(19) United States
(12) Patent Application Publication
(10) Pub. No.: US 2015/0079410 A1
(43) Pub. Date: Mar. 19, 2015

(54) Control of Surface Charges by Radical Scavengers and Antioxidants as a Principle of Antistatic Polymers Protecting Electronic Circuitry

(71) Applicant: Northwestern University, Evanston, IL (US)

(72) Inventors: Bartosz A. Grzybowski, Evanston, IL (US); Hasan Tarik Baytekin, Evanston, IL (US); Bilge Baytekin, Evanston, IL (US)

(21) Appl. No.: 14/490,223

(22) Filed: Sep. 18, 2014

Related U.S. Application Data
(60) Provisional application No. 61/879,607, filed on Sep. 18, 2013.

(51) Int. Cl. C08K 5/32; B05D 1/18

(52) U.S. Cl. CPC C08K 5/32; B05D 1/18
USPC 428/447; 524/189; 427/430.1; 427/387

(57) ABSTRACT

Anti-static polymer compositions for use with electronic devices susceptible to static electricity are provided. The composition includes a polymer and a free radical scavenger additive.

### CROSS-REFERENCE TO RELATED APPLICATIONS

This application claims benefit of priority under 35 U.S.C. 119 to U.S. provisional patent application Ser. No. 61/879,607, filed Sep. 18, 2013, and entitled “Control of Surface Charges by Radical Scavengers and Antioxidants as a Principle of Antistatic Polymers Protecting Electronic Circuitry,” the content of which is herein incorporated by reference in its entirety.

### STATEMENT REGARDING FEDERALLY SPONSORED RESEARCH OR DEVELOPMENT

This invention was made with government support under DE-SC0000989 awarded by the Department of Energy. The government has certain rights in the invention.

### FIELD OF INVENTION

The present disclosure relates to antistatic polymers for electronic circuitry.

### BACKGROUND OF INVENTION

Beyond kids' play at electrifying balloons and “static cling,” accumulation of static electricity on polymers is a serious technological problem responsible for shocks, explosions, as well as damage of satellites and other electronic equipment measured in billions of dollars per annum. Despite centuries of research, it is not known why certain polymers charge more than others and, most importantly, how to design polymers that would resist static electricity and could potentially act as general-purpose antistatic coatings avoiding the limitations of currently used materials.

Strategies of controlling static electricity and electrostatic discharge are known in the art. In the existing approaches, specialized materials such as ionic conductors, carbon or metal-filled resins, or conducting polymers are used to increase the humidity or conductivity of antistatic coatings resulting in charge dissipation (M. Angelopoulos, IBM J. Res. Dev. 45, 57 (2001); M. Tolinski, Additives for Polyolefins: Getting the Most out of Polypropylene, Polyethylene and TPO (Elsevier, Oxford, 2009), pp 79-91). These “traditional antistatics” all have their limitations (e.g., ionic conductors are moisture sensitive, resins require high levels of loading that alter material properties) which become even more prominent with the ever-decreasing sizes of the circuits. Their resistivities are typically 10¹⁹-10¹² W/sq., relatively close to 10⁹ W/sq, which is the “classified electrostatic discharge (ESD) level” of resistivity required to prevent the damage of sensitive electronics (M. Tolinski, Additives for Polyolefins: Getting the Most out of Polypropylene, Polyethylene and TPO (Elsevier, Oxford, 2009), pp 79-91).

Electrification of polymers due to physical contact leads to spatially heterogeneous transfer of charge and material, as well as the creation of mechanoradicals upon homolytic bond cleavage. See, for examples, the works of H. T. Baytekin et al. Science 333:308 (2011); H. T. Baytekin et al. Angew. Chem. Int. Ed. 51:4843 (2012); B. Baytekin, H. T. Baytekin, & B. A. Grzybowski, J. Am. Chem. Soc. 134:7223 (2012); W. R. Salaneck & A. Paton, J. Appl. Phys. 47:144 (1976); T. A. L. Burgo et al. Langmuir 28:7407 (2012); and M. Williams, AIP Adv. 2:010701 (2012).

### BRIEF SUMMARY

In a first aspect, an anti-static polymer composition is provided. The composition includes a polymer and a free radical scavenger additive.

In a second aspect, an electrostatic sensitive device having reduced propensity to retain static electricity is provided. The device includes the electrostatic sensitive device and an anti-static polymer composition. The anti-static polymer composition includes a polymer and a free radical scavenger additive.

In a third aspect, a method of reducing the propensity of a polymer to retain static electricity upon electrification of the polymer is provided. The method includes the step of doping the polymer with a free radical scavenger additive.

These and other features, objects and advantages of the present invention will become better understood from the description that follows. In the description, reference is made to the accompanying drawings, which form a part hereof and in which there is shown by way of illustration, not limitation, embodiments of the invention.

### BRIEF DESCRIPTION OF THE DRAWINGS

The features, objects and advantages other than those set forth above will become more readily apparent when consideration is given to the detailed description below. Such detailed description makes reference to the following drawings.

FIG. 1A depicts a representative AFM phase image (AFM height) of a PDMS polymer before charging. Image size=5.4 mm.

FIG. 1B depicts a representative MFM image of a PDMS polymer before charging. Image size=5.4 mm.

FIG. 1C depicts a representative KFM image (AFM height) of a PDMS polymer before charging. Image size=5.4 mm.

FIG. 1D depicts a representative AFM phase image (AFM height) of material transfer regions on contact-charged surfaces an acrylate polymer (Scotch™ tape). Scale bar=1 μm.

FIG. 1E depicts a representative MFM image of radicals on contact-charged surfaces an acrylate polymer (Scotch™ tape) as in FIG. 1D. Scale bar=1 μm.

FIG. IF depicts a representative KFM image of surface charges on contact-charged surfaces an acrylate polymer (Scotch™ tape) as in FIG. 1D. Scale bar=1 μm.

FIG. 1G depicts a representative cross-correlation map between AFM phase image and MFM image of contact-charged surfaces an acrylate polymer (Scotch™ tape) from data presented in FIGS. 1D, E. Map shown in the figure is highly correlated with peak |g(x,y)| values as high as 0.7 and p-value <<0.01 (that is, >99% confidence interval).

FIG. 1H depicts a representative cross-correlation map between MFM image data and KFM image data of contact-charged surfaces an acrylate polymer (Scotch™ tape) from data presented in FIGS. 1E, F. Map shown in the figure is highly correlated with peak |g(x,y)| values as high as 0.7 and p-value <<0.01 (that is, >99% confidence interval).

FIG. 1I depicts a representative cross-correlation map between AFM phase image data and KFM image data of contact-charged surfaces an acrylate polymer (Scotch™ tape) from data presented in FIGS. 1D, F. Map shown in the figure is highly correlated with peak |g(x,y)| values as high as 0.7 and p-value <<0.01 (that is, >99% confidence interval).

FIG. 1J depicts a representative KFM image of surface charges on a PDMS polymer corona-charged (here, negatively) using an electrostatic gun. Scale bar=1 μm.

FIG. 1K depicts a representative MFM image of radicals on a PDMS polymer corona-charged (here, negatively) using an electrostatic gun. Scale bar=1 μm.

FIG. 1L depicts a representative cross-correlation map between MFM image data and KFM image data of corona-charged surfaces a PDMS polymer from data presented in FIGS. 1J, K. Map shown in the figure is highly correlated with peak |g(x,y)| values as high as 0.7 and p-value <<0.01 (that is, >99% confidence interval).

FIG. 2 depicts several of the compounds evaluated in this disclosure.

FIG. 3A shows results of a representative experiment in which PDMS pieces contact charged against PS and doped with a-tocopherol (red), HALS (yellow), or DPPH (purple) develop less charge than native/pure PDMS (blue). Error bars are based on at least four independent experiments for each material/condition. Net charge densities in nC/cm² are similar to those observed before.

FIG. 3B shows results of a representative experiment in which less positive charge accumulates on DPPH-PDMS when DPPH concentration increases; [DPPH]=0 M, 10⁻⁴ M, and 10⁻³ M (grey, lila, and purple markers, respectively). Error bars are based on at least four independent experiments for each material/condition. Net charge densities in nC/cm² are similar to those observed before.

FIG. 3C shows results of a representative experiment in which the scavenger analogue DPPH-H (orange) has no effect on charging. Error bars are based on at least four independent experiments for each material/condition. Net charge densities in nC/cm² are similar to those observed before.

FIG. 3D depicts a representative plot of a typical charge decay curve for pure PDMS contact-charged positively against PS.

FIG. 3E depicts a representative plot of a typical charge decay curve for PDMS/1 mM DPPH contact-charged against PS.

FIG. 3F depicts a representative plot of a typical charge decay curve for pure PDMS charged by corona discharge either (+) or (−). Polarity of charging depends on the polarity of the ions produced by the ion gun but the rates of discharge do not (note: the y-axis has the absolute values of surface charge density). The image in the inset give the corresponding MFM map recorded after 24 hrs.

FIG. 3G depicts a representative plot of a typical charge decay curve for PDMS 5 mM DPPH charged by corona discharge either (+) or (−). Polarity of charging depends on the polarity of the ions produced by the ion gun but the rates of discharge do not (note: the y-axis has the absolute values of surface charge density). The image in the inset give the corresponding MFM map recorded after 24 hrs. More radicals (white spots) are present on pure PDMS than on PDMS/DPPH.

FIG. 4A depicts a representative scanning electron microscopy experiment where pure PDMS is charged with a 3.0 kV beam at 500× magnification and subsequently imaged at 100× magnification immediately after charging (panel (i)) or ten seconds after charging (panel (ii)).

FIG. 4B depicts a representative scanning electron microscopy experiment where a PDMS/1.0 mM DPPH film is charged with a 3.0 kV beam at 500× magnification and subsequently imaged at 100× magnification immediately after charging (panel (i)) or ten seconds after charging (panel (ii)). Scale bar=200 μm.

FIG. 5A depicts a representative AFM phase image for visualizing material transfer during contact-charging of the surface of sticky side Scotch™ tape (image size 10 μm×10 μm).

FIG. 5B depicts a representative AFM height image for visualizing material transfer during contact-charging of the surface of sticky side Scotch™ tape (image size 10 μm×10 μm).

FIG. 5C depicts a representative MFM plot of radical species on the surface of sticky side Scotch™ tape (image size 10 μm×10 μm) following contact-charging at t=0 hr (panel (i)) and t=24 hr (panel (ii))

FIG. 5D depicts a representative KFM plot of charged species on the surface of sticky side Scotch™ tape (image size 10 μm×10 μm) following contact-charging at t=0 hr (panel (i)), t=3 hr (panel (ii)) and t=24 hr (panel (iii)).

FIG. 5E depicts a scan along the yellow line in the MFM plot image as presented in FIG. 5C.

FIG. 5F depicts a scan along the yellow line in the KFM plot image as presented in FIG. 5D.

FIG. 6A depicts a qualitative illustration of orbital interactions of radicals and cations on contact charged surfaces.

FIG. 6B depicts a qualitative illustration of orbital interactions of radicals and anions on contact charged surfaces.

FIG. 7A depicts a representative plot of the average density for polystyrene (PS) beads contact charged by shaking in PS Petri dishes in the absence of DPPH (panel (i)), the average density for PS beads contact charged by shaking in PS Petri dishes in which one of the contacting PS materials is doped with DPPH (panel (ii)) and the average density for PS beads contact charged by shaking in PS Petri dishes in which both contacting PS materials are doped with DPPH (panel (iii)). Error bars correspond to standard deviations of the charges on 25 beads used in each experiment.

FIG. 7B depicts a representative photographic time course (panel (i)—0 hr.; panel (ii)—1 hr.; panel (iii)—2 hrs) of PDMS block doped with 1 mM of DPPH contact charged against PS to 0.75 nC/cm² attracts significantly less small shreds and “de-dusts” completely within ca. 1 hr compared to undoped PDMS piece in FIG. 7C. Scale bar=1 cm

FIG. 7C depicts a representative photographic time course (panel (i)—0 hr.; panel (ii)—5 hr.; panel (iii)—18 hrs) of equally shaped and charged PDMS piece in the absence of DPPH. Scale bar=1 cm.

FIG. 7D depicts a representative plot of the average density of positive charge for polycarbonate (PC) beads ( 1/16 inch) contact charged by shaking against a PC surface in the absence of DPPH (panel (i)), the average density of positive charge for PC beads contact charged by shaking against a PC surface in which one of the contacting PC materials is doped with 1 mM DPPH (panel (ii)) and the average density for PC beads contact charged by shaking against a PC surface in which both contacting PC materials are doped with 1 mM DPPH (panel (iii)). Error bars correspond to standard deviations of the charges on 25 beads used in the experiment.

FIG. 7E depicts a representative plot of the average density of negative charge for poly (methyl methacrylate) (PMMA) pieces (1 cm×1 cm×0.5 cm) charged against a PMMA surface in the absence of DPPH (panel (i)), the average density of negative charge for PMMA pieces contact charged by shaking against a PMMA surface in which one of the contacting PMMA materials is doped with 1 mM DPPH (panel (ii)) and the average density for PMMA pieces contact charged by shaking against a PMMA surface in which both contacting PMMA materials are doped with 1 mM DPPH (panel (iii)). Error bars correspond to standard deviations of the charges on 25 pieces used in the experiment.

FIG. 8A depicts an electronic circuit layout that includes four transistors in which in which four JFETs are wired in parallel to one another, each is connected to an associated LED, and all are in series to a common charge collecting antenna through which electrostatic discharge is applied.

FIG. 8B depicts the four JFET transistor layout, wherein only transistor #2 had the cap removed and the gate covered with PS/DPPH.

FIG. 8C depicts electrostatic positive charging of the circuit by applying an ion gun to the collecting antenna.

FIG. 8D depicts electrostatic negative charging of the circuit by applying the ion gun to the collecting antenna.

FIG. 9A depicts a circuit scheme for a capacitor-discharge test.

FIG. 9B depicts that the transistors of the circuit being tested are subjected to a discharge from the circuit capacitor through a common metal antenna.

FIG. 9C depicts an experimental photograph of the circuit layout, wherein after the removal of its cap, transistor #1 (T1) was covered with DPPH-PDMS while transistor #2 (T2) was not modified.

FIG. 9D depicts discharging the capacitor on transistors through metal antenna connected to the gates of the transistors.

FIG. 9E depicts transistor function before capacitor discharge when subjected to positive charging (panel (i)) and negative charging (panel (ii)) by an ion gun.

FIG. 9F depicts transistor function after capacitor discharge when subjected to positive charging (panel (i)) and negative charging (panel (ii)) by an ion gun.

While the present invention is amenable to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all modifications, equivalents and alternatives falling within the spirit and scope of the invention as defined by the embodiments above and the claims below. Reference should therefore be made to the embodiments and claims herein for interpreting the scope of the invention.

### DETAILED DESCRIPTION

The compositions and methods now will be described more fully hereinafter with reference to the accompanying drawings, in which some, but not all permutations and variations of embodiments of the invention are shown. Indeed, the invention may be embodied in many different forms and should not be construed as limited to the embodiments set forth herein. These embodiments are provided in sufficient written detail to describe and enable one skilled in the art to make and use the invention, along with disclosure of the best mode for practicing the invention, as defined by the claims and equivalents thereof.

Likewise, many modifications and other embodiments of the compositions and methods described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

Moreover, reference to an element by the indefinite article “a” or “an” does not exclude the possibility that more than one element is present, unless the context clearly requires that there be one and only one element. The indefinite article “a” or “an” thus usually means “at least one.”

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the particular system under study, and can be readily appreciated by one of skill in the art.

As used herein, “doping” refers to disposing a substance or composition on a surface by any means known in the art, including dipping, brushing, flow-coating, screen-printing, slot-die coating, gravure coating, powder coating, spraying and spin-coating.

Ranges recited herein include the defined boundary numerical values as well as sub-ranges encompassing any non-recited numerical values within the recited range. For example, a range from about 0.01 mM to about 10.0 mM includes both 0.01 mM and 10.0 mM. Non-recited numerical values within this exemplary recited range also contemplated include, for example, 0.05 mM, 0.10 mM, 0.20 mM, 0.51 mM, 1.0 mM, 1.75 mM, 2.5 mM 5.0 mM, 6.0 mM, 7.5 mM, 8.0 mM, 9.0 mM, 9.9 mM, among others. Exemplary sub-ranges within this exemplary range include from about 0.01 mM to about 5.0 mM; from about 0.1 mM to about 2.5 mM; from about 2.0 mM to about 6.0 mM, among others.

Formulations and coatings are disclosed for doping polymers with small amounts of free-radical scavengers to reduce static development and to prevent static charging. The present inventors discovered that electric charges and the radicals co-localize to the same nanoscopic regions of electrified polymers. The presence of radicals stabilizes the charged species; conversely, the removal of radicals destabilizes charge domains and results in a rapid discharge of the electrified material. The disclosed formulations transform various common polymers into robust antistatic coatings to protect semiconductor devices from failure caused by the build-up of static electricity.

### Electric Charges and Radicals Co-Localize in Electrified Polymers

Various types of polymers were electrified either by contact charging them against other materials or by exposing to a corona discharge from an electrostatic gun. Exemplary polymers that were evaluated include acrylate-based adhesive Scotch™ tape, poly(dimethyl siloxane) (PDMS), poly(methyl methacrylate) (PMMA), polycarbonate (PC) and polystyrene (PS). These charged surfaces were examined by several atomic force microscopy (AFM) modalities on a BrukerDimension Icon system. Kelvin Force Microscopy (KFM) was used to visualize surface charge distributions, while Magnetic Force Microscopy (MFM) visualized the distribution of radicals. In addition, conventional AFM was used to visualize surface topography while AFM phase and AFM PeakForce Quantitative Nanomechanical Property Mapping® (PF-QNM) modes provided quantitative elastic property mapping of the surfaces at the nanoscopic level and allowed identification of regions where material was transferred (if electrification involved physical contact).

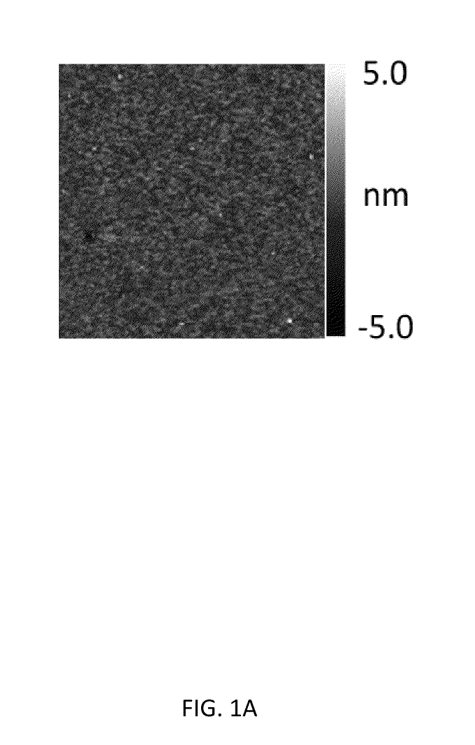

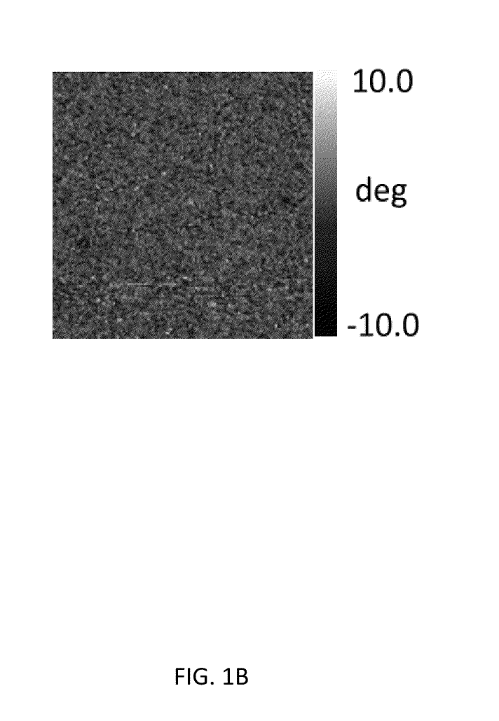

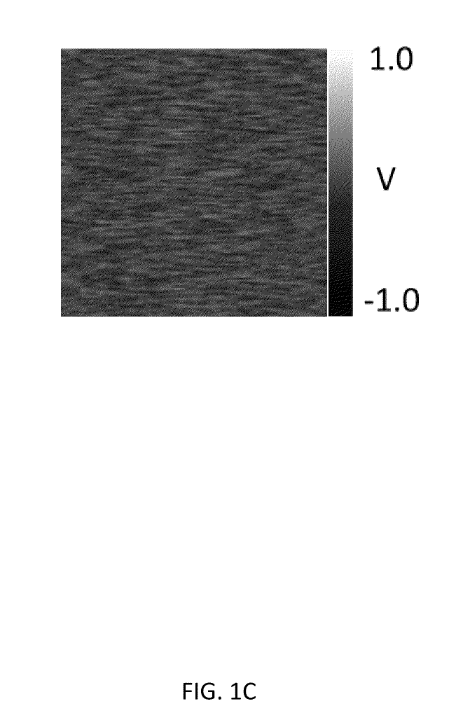

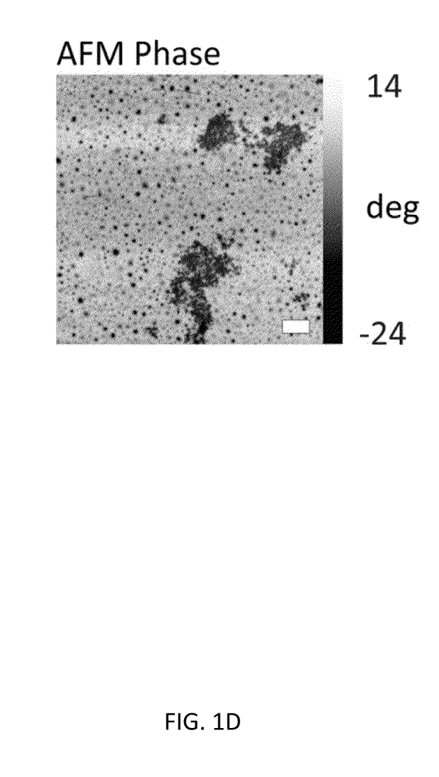

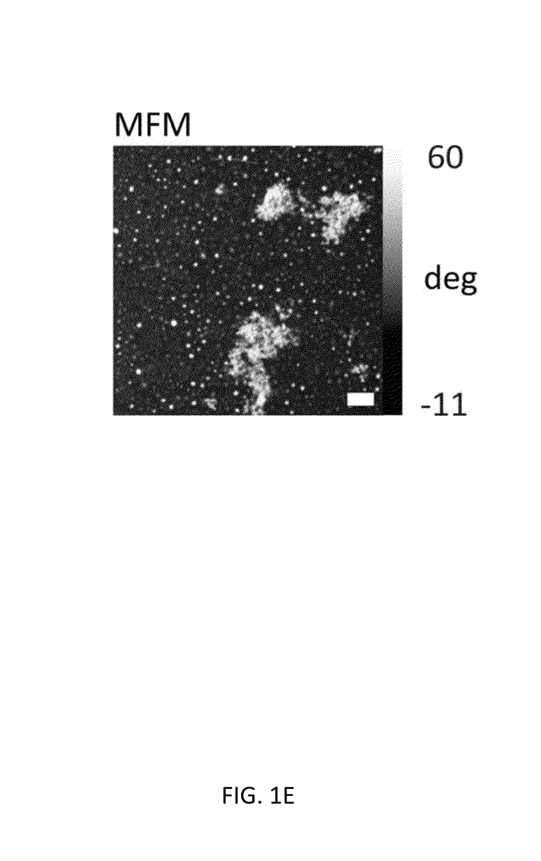

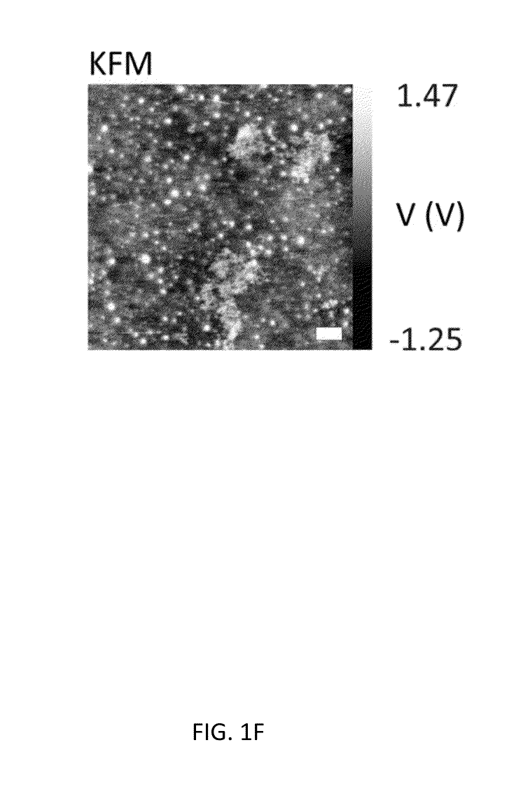

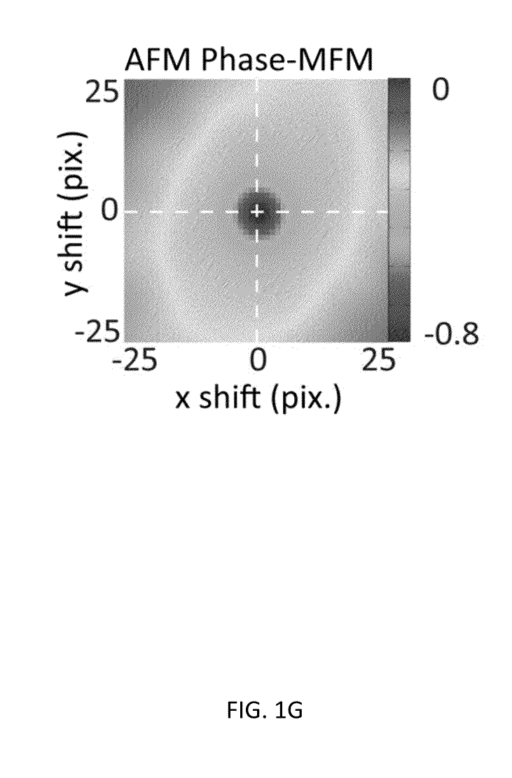

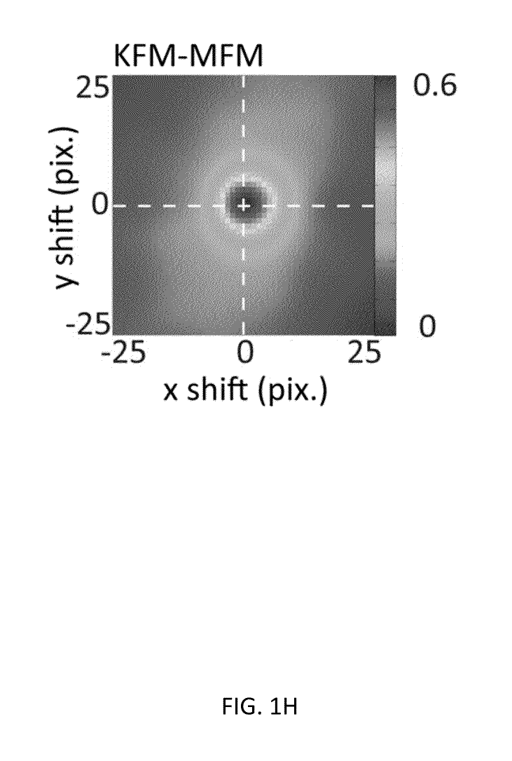

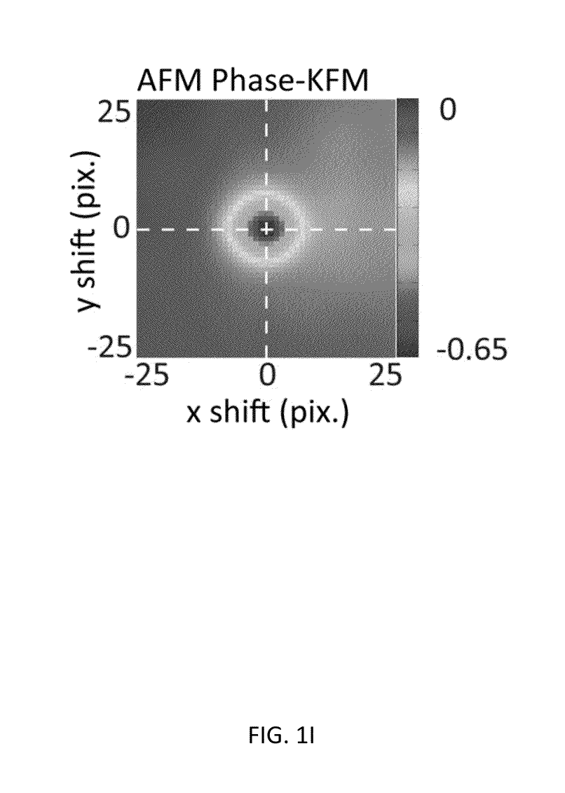

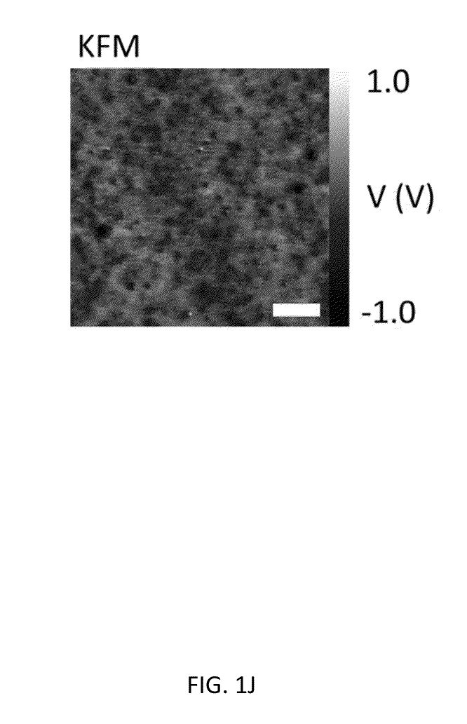

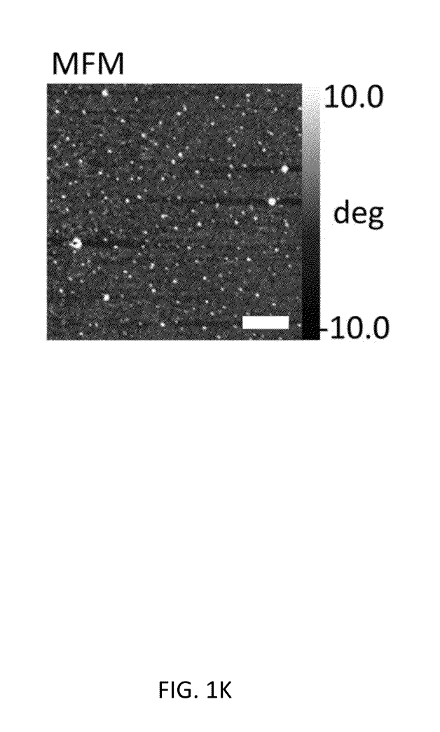

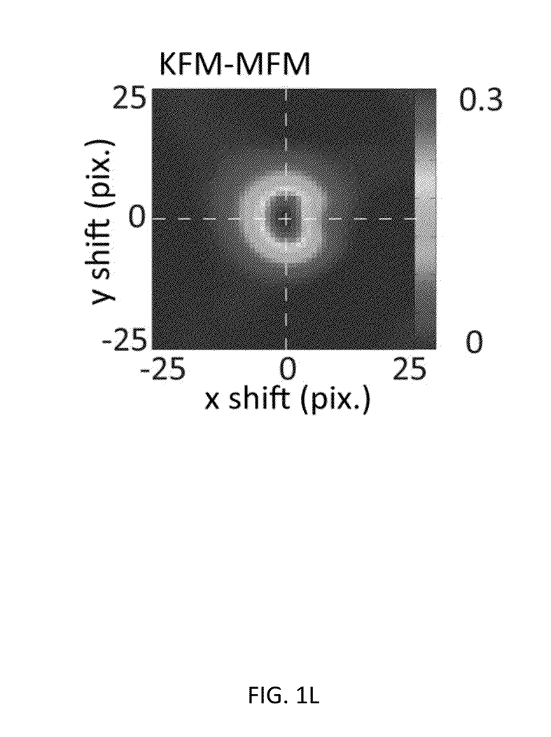

FIGS. 1A-C show typical experimental AFM-phase, MFM and KFM images of the same region of an exemplary uncharged polymer (here, PDMS). FIGS. 1D-I show typical experimental AFM-phase, MFM and KFM images of the same region of an exemplary contact-charged polymer (here, Scotch™ tape) as well as the correlation maps for different image pairs. In these maps, the peaks at (0,0) indicate that the two images being compared are highly correlated and can be superimposed. In other words, the regions where the material is transferred correspond faithfully to the regions that develop static charges ((+/−) charge “mosaics”) and to the regions that contain the radicals. Without the invention being limited or bound by any particular theory of operation, these observations are congruent with a scenario in which contact electrification is due to the transfer of nanoscopic patches of material that entails both heterolytic bond cleavage giving rise to charged species and homolytic bond cleavage giving rise to radicals. Thus, all these phenomena are spatially co-localized.

We considered whether charge-radical co-localization applies to polymers charged not only by contact but also by discharge. Charging by electrostatic/corona discharge from an electrostatic gun does not involve polymer transfer but produces charged species of both polarities as well as radicals. The KFM analysis of the polymers electrified by corona discharge reveals charged regions (of polarity dependent on gun squeezing/releasing, see FIG. 1J for negatively charged PDMS), while MFM gives distinct signals due to radicals (FIG. 1K). These species co-localized as evidenced by the correlation maps (FIG. 1L).

### Free Radical Scavengers Reduce Development/Retention of Static Electricity on Polymers

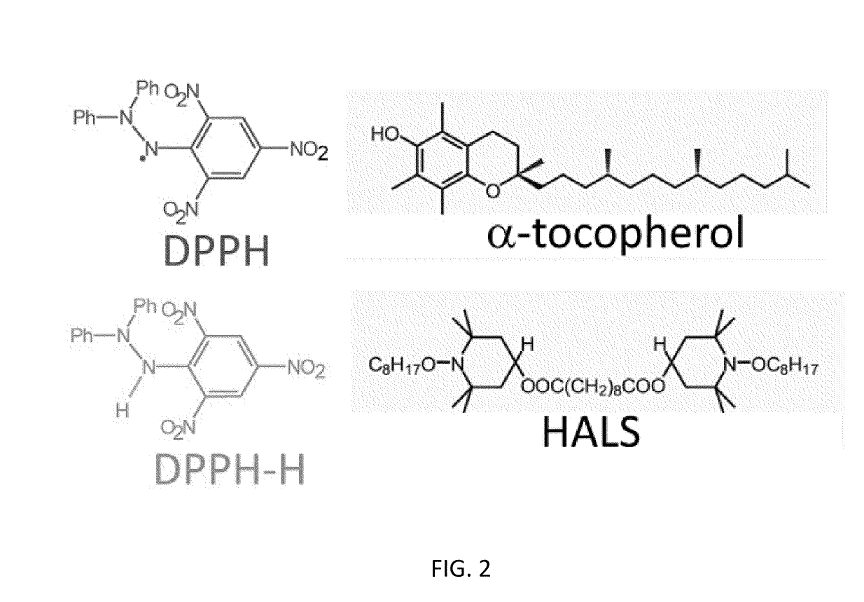

The co-localization of surface charges and radicals suggests a possible interplay between these species. A series of charging experiments were performed with native polymers as well as polymers doped with small amounts of chemical substances scavenging the radicals such as (±)-α-tocopherol (vitamin E), bis(1-octyloxy-2,2,6,6-tetramethyl-4-piperidyl) sebacate (HALS), or 2,2-diphenyl-1-picrylhydrazyl (DPPH) (FIG. 2).

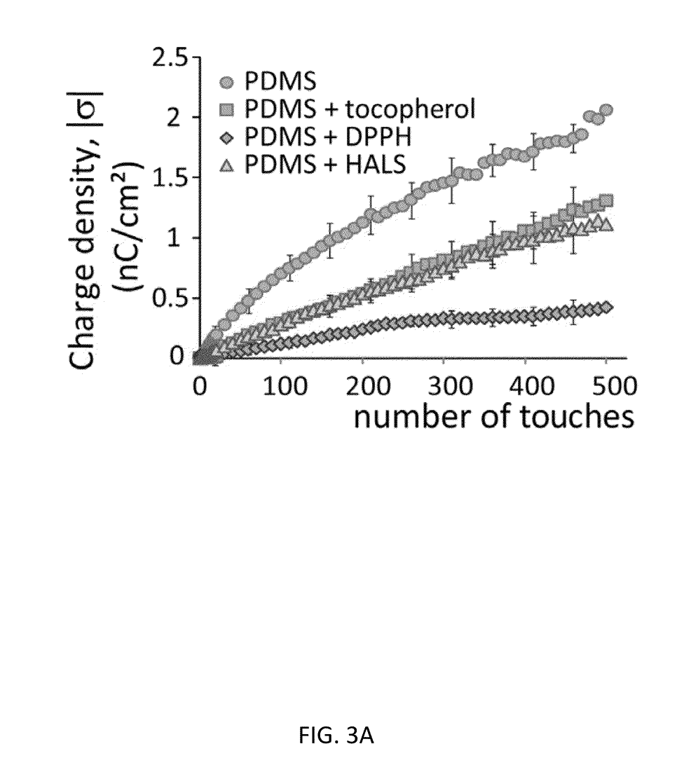

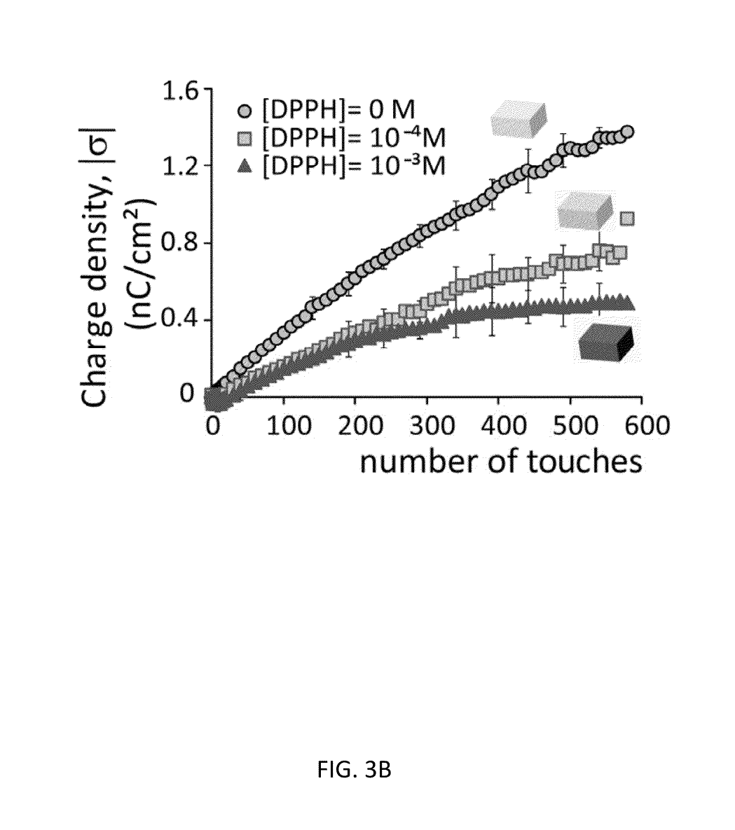

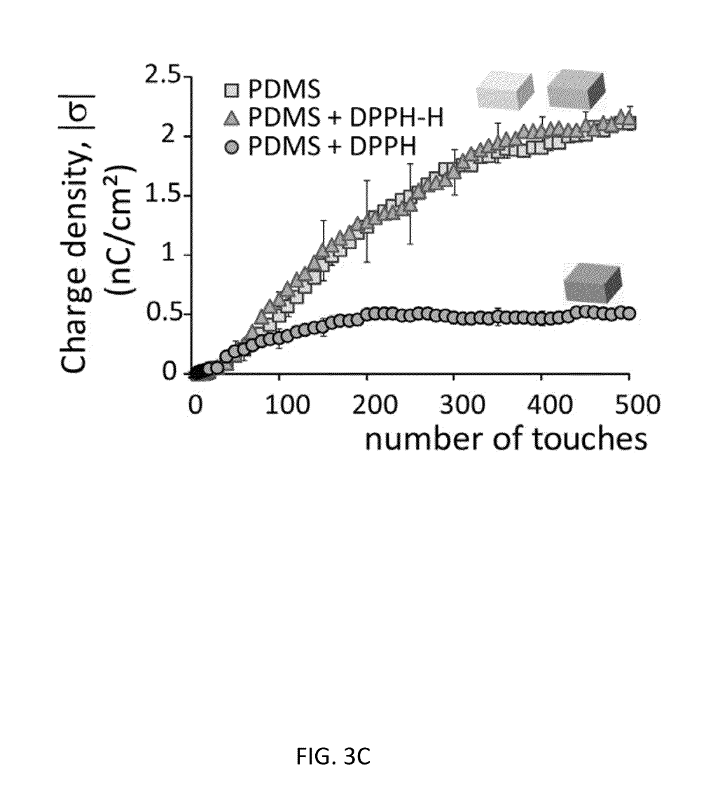

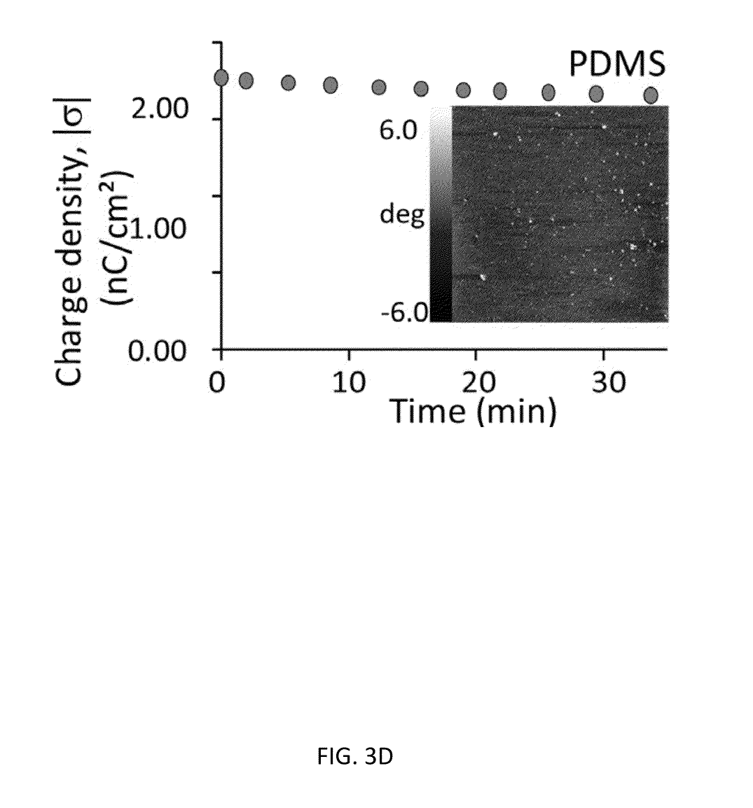

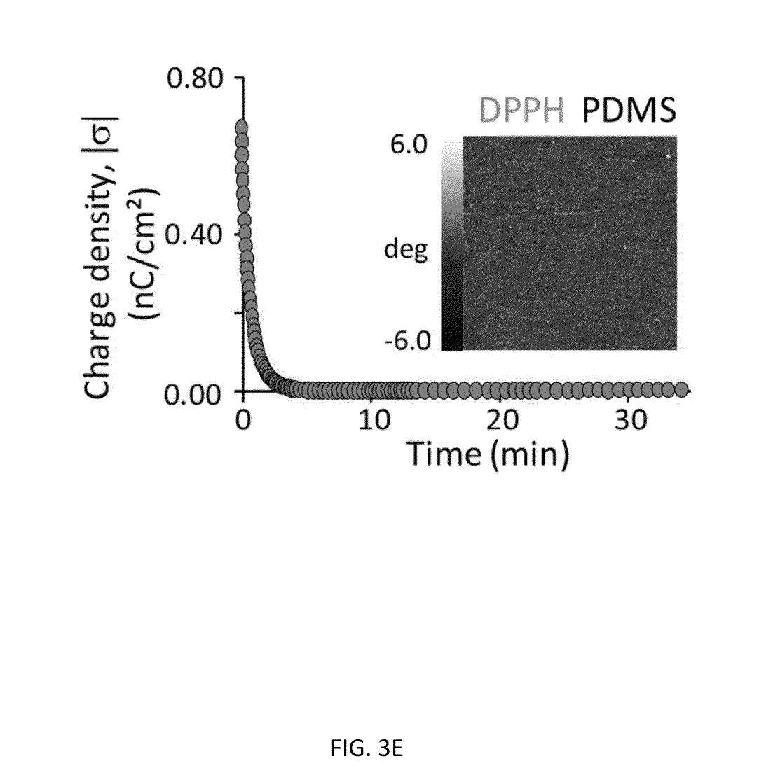

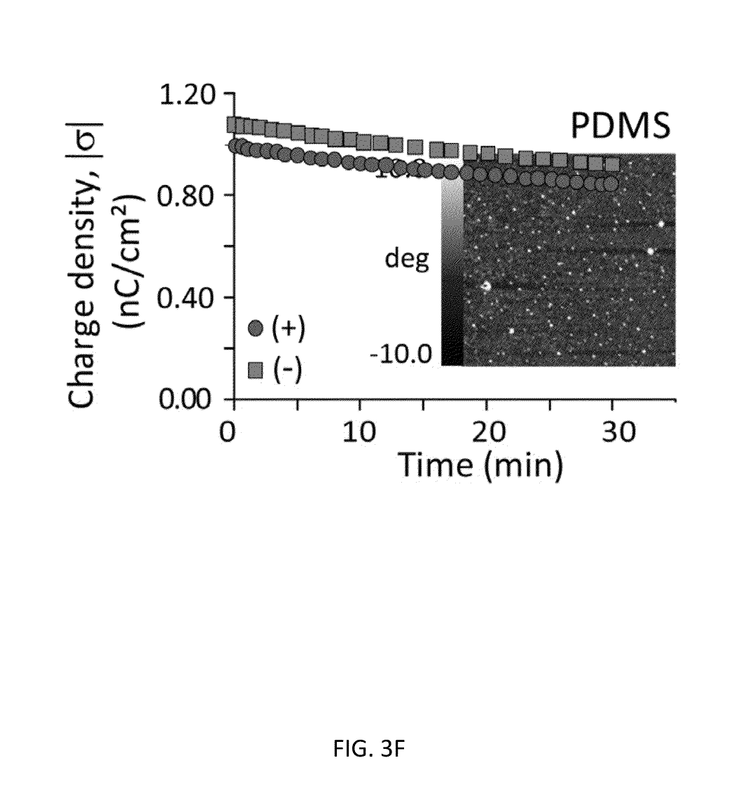

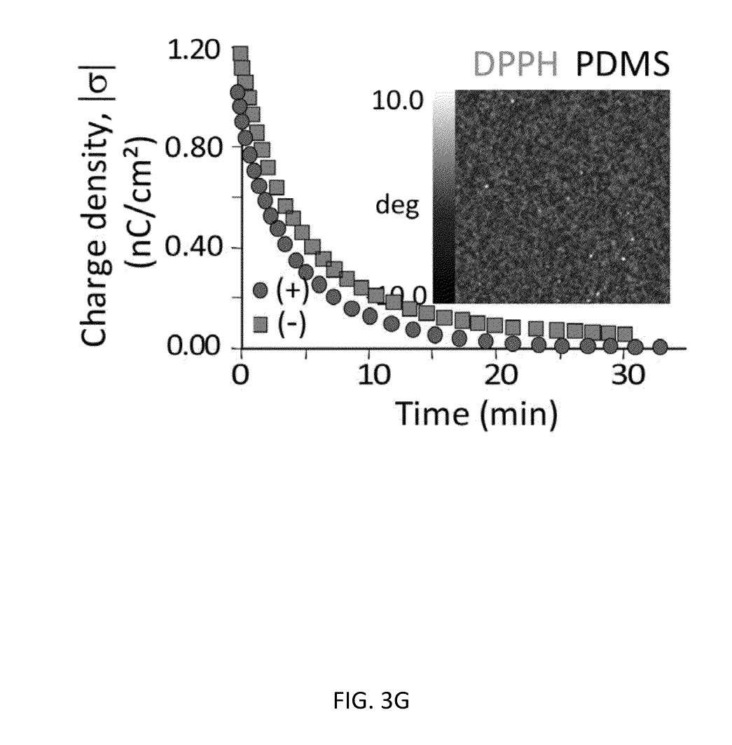

Data in FIG. 3A illustrates that the presence of radical scavengers reduces the propensity of polymers to develop static electricity during contact charging. Moreover, the magnitude of charge decreases with increasing dopant concentration (FIG. 3B). This effect cannot be attributed to the alterations in the mechanical properties of PDMS, which remain unchanged by this low level of doping. Furthermore, the part of the dopant that affects radical scavenging also affects the charging.

The dopant 2,2-diphenyl-1-picryl hydrazine (“DPPH-H”) differs from the DPPH scavenger by only one hydrogen atom. Despite the close structural similarity, this molecule is not able to scavenge radicals. Importantly, when the PDMS was doped with DPPH-H, its charging propensity was indistinguishable from pure PDMS (FIG. 3C). The same effects are observed upon corona discharge where doped polymers accumulate only up to 10% of the charge that is detected on the native/undoped polymers under same discharge and subsequent measurement conditions.

The role of radicals is to stabilize the charges. This is evidenced by experiments illustrated in FIGS. 3D-G, where the spontaneous discharge in air of the contact- or corona-electrified polymers was monitored as a function of time. Irrespective of the method and polarity of charging, pure polymers discharge over the course of hours (FIGS. 3D,F), while the same polymers doped with radicals scavengers discharge within minutes (FIGS. 3E,G).

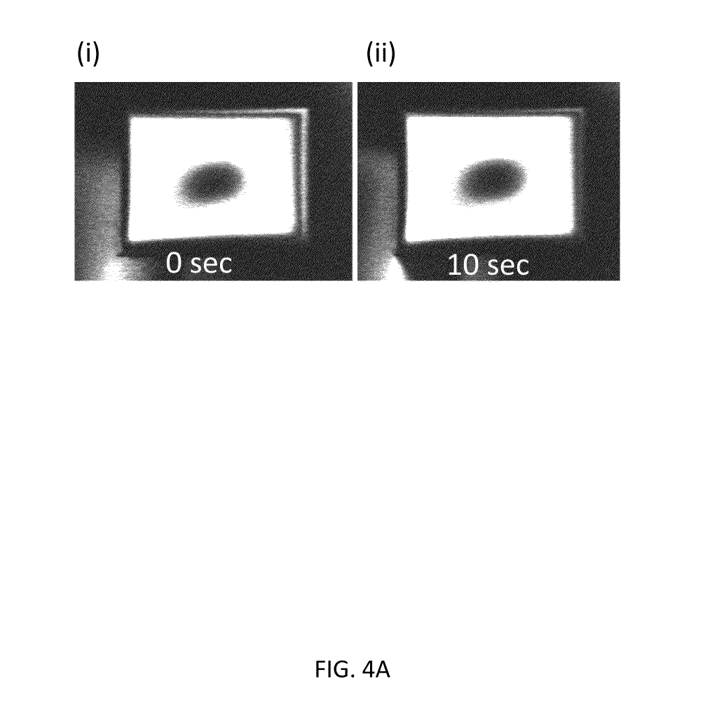

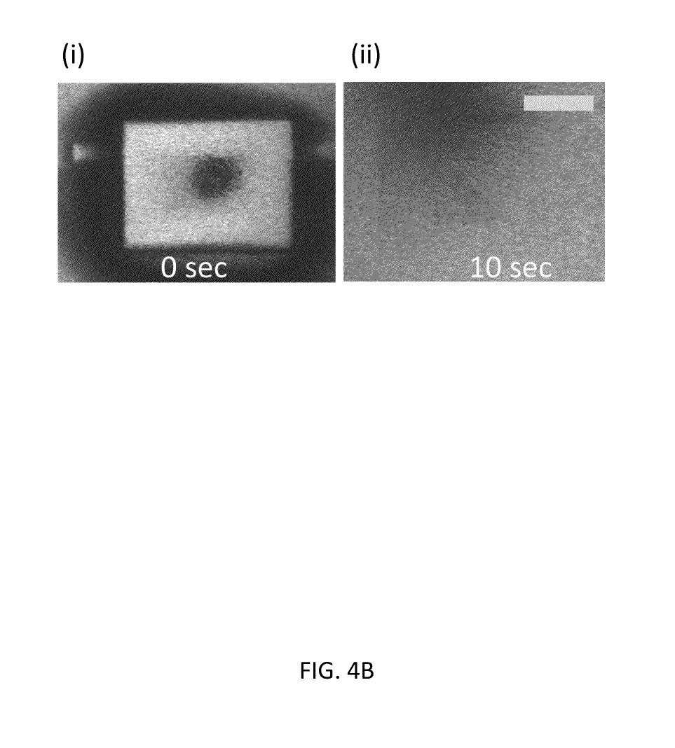

Scanning electron microscopy (SEM) charging experiments were performed with pure PDMS and PDMS/DPPH films to investigate charge dissipation kinetics. When pure PDMS is charged under SEM, the region charged by electrons persists for minutes (FIG. 4A). When the same experiment is performed on a PDMS/1.0 mM DPPH film, charge dissipates within <10 sec (FIG. 4B).

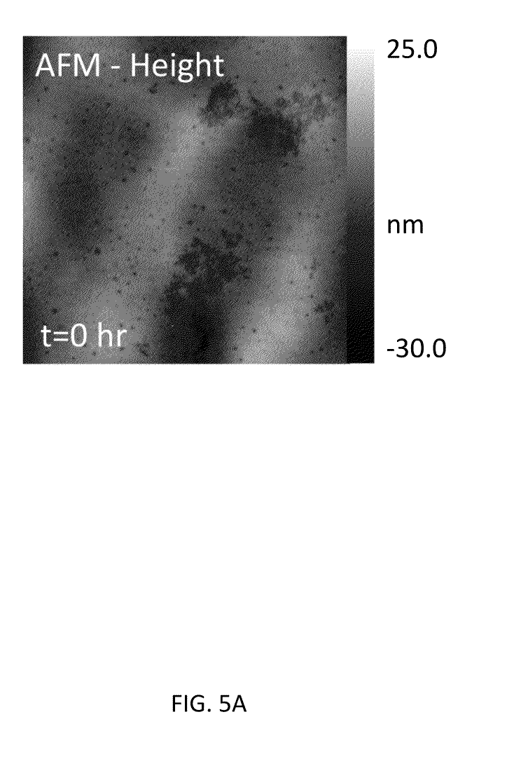

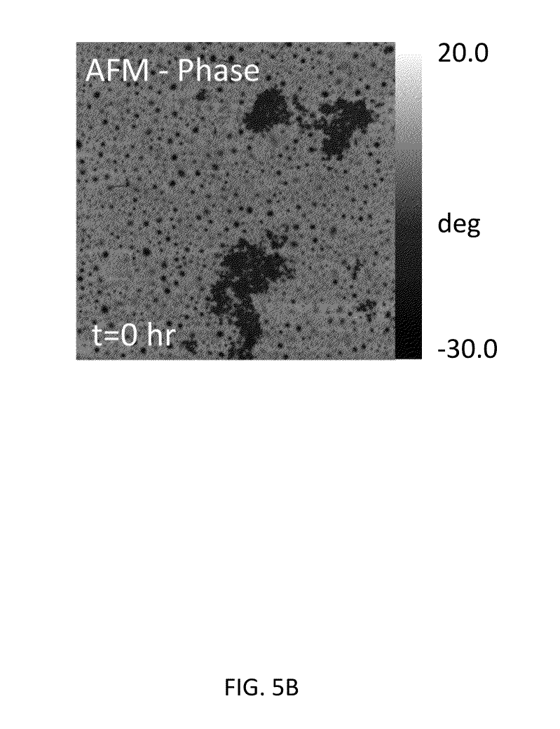

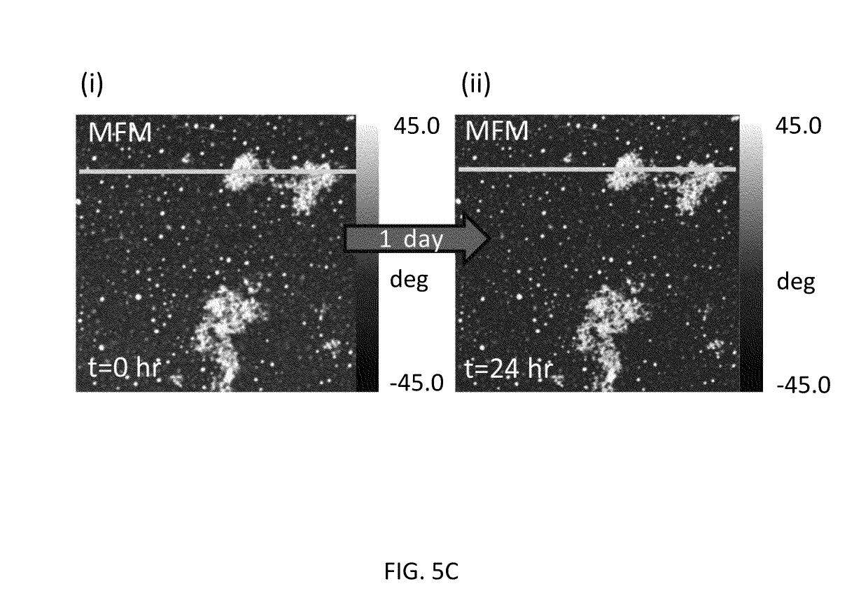

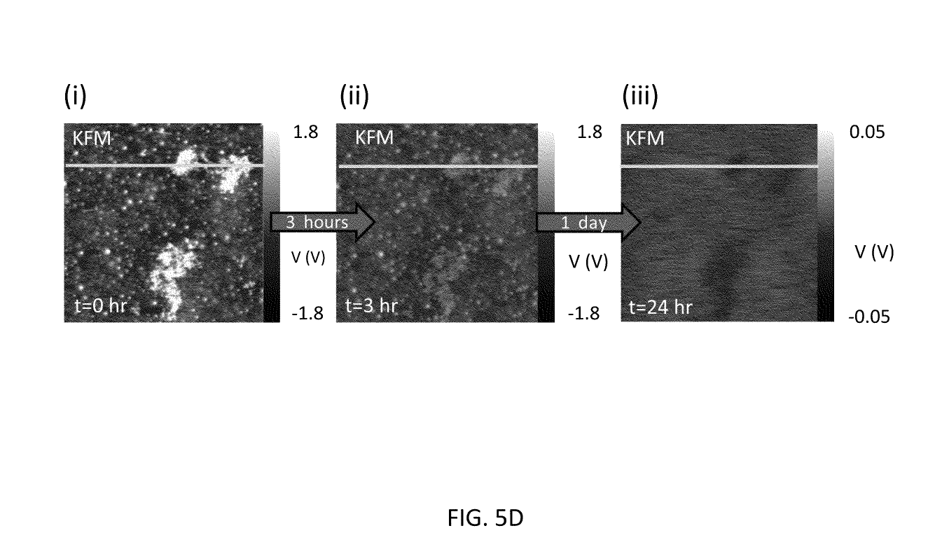

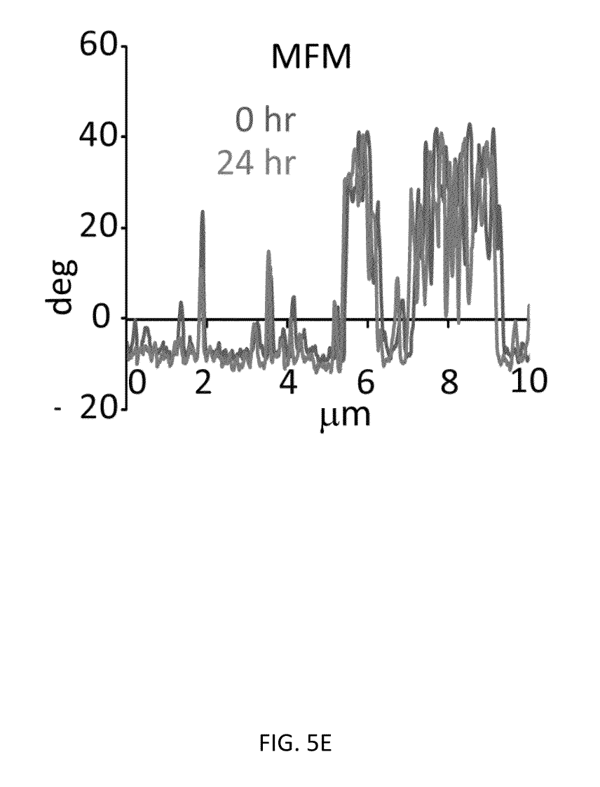

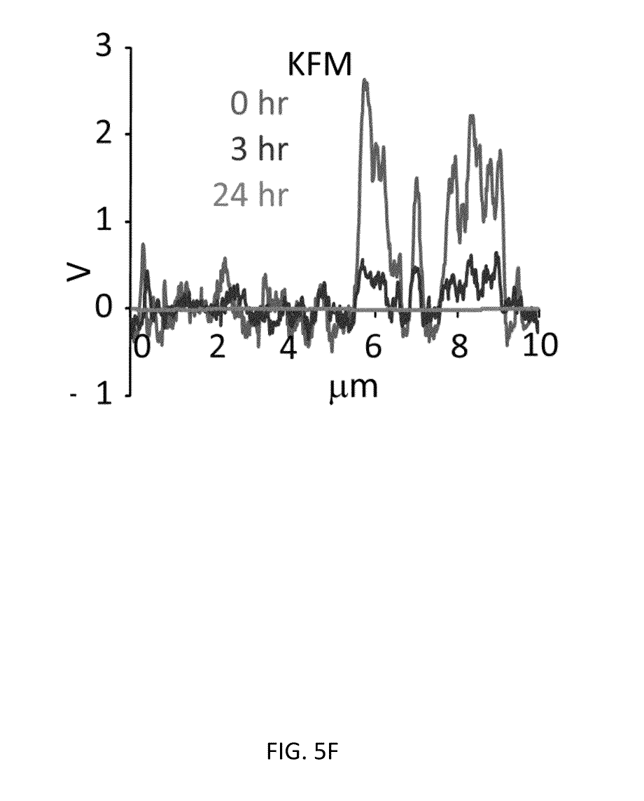

To further explore the kinetic relationship of radical species and charged species life-times, AFM, MFM and KFM imaging of surfaces during charge decay was performed. AFM phase detecting changes in material organization on the surface is a more sensitive method of visualizing material transfer during contact-charging than AFM-height (compare FIGS. 5A,B). FIGS. 5C,D illustrate that the radicals visualized by MFM have significantly longer life-times than the charged species imaged by KFM. Although almost all charge decayed after 24 hrs, as measured by KFM (FIG. 5E), MFM image still keeps its initial magnitude/contrast (FIG. 5F). Thus, MFM measurements are not affected by the surface charges.

Thus, discharge kinetics is related to the presence or absence of radicals. The MFM maps accompanying the discharge curves in FIGS. 3D-G and FIG. 5 demonstrate that for slowly discharging pure PDMS, the radicals are still present even after 24 hours. In contrast, for the rapidly discharging PDMS/DPPH, there are much less radicals left on the surface after the same time.

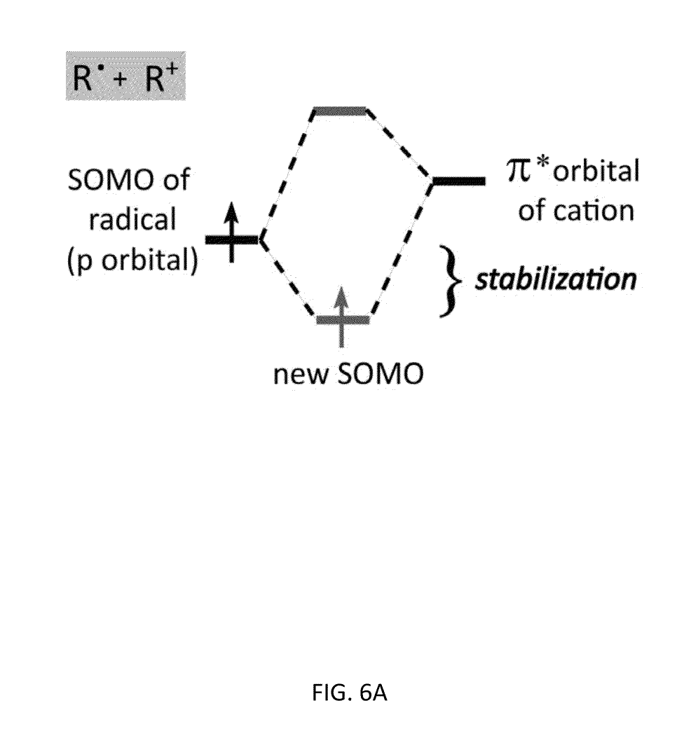

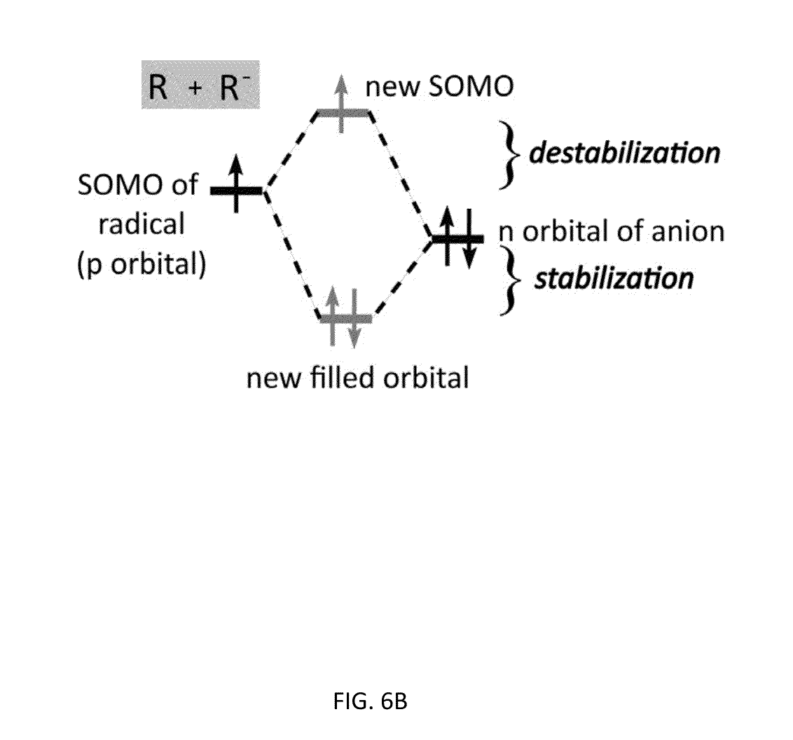

The radicals that form as a result of homolytic bond cleavage during electrification are mostly peroxy radicals, ROO. known for their relatively high stability due to resonance stabilization. Without the invention being bound or limited by any particular theory of operation, the charge stabilization can be rationalized, at least, qualitatively, on the basis of molecular orbital theory whereby the singly-occupied molecular orbitals (SOMO) of the radicalic species interact with the empty orbitals of cationic species (FIG. 6A) or with the filled orbitals of the anionic species (FIG. 6B). When the radical scavengers are present, they either (i) trap and stabilize the radicals (e.g., as in Vitamin E which forms a tocopheroxy radical) thus lowering the energy of SOMO and preventing it from effective participation in electron sharing; or (ii) annihilate the radicals by reacting with them (e.g., DPPH reacts into DPPH-R whereas HALS forms N-alkoxy derivatives).

Alternative explanations based on the dopants increasing conductivity of the polymers do not apply. First, surface resistivities for both undoped and doped polymers are on the order of 10¹⁶ W/sq well above 10¹⁰-10¹² W/sq for antistatic materials. Second, there is no increased ability of the doped polymers to condense surface water. The contact angles do not change significantly upon doping, e.g., 106.5°±1.3° for pure PDMS and 107.0°±0.8° for PDMS/0.5×10⁻² M DPPH). In this context, the observed trends remain unchanged in a water free-atmosphere, under dry Ar.

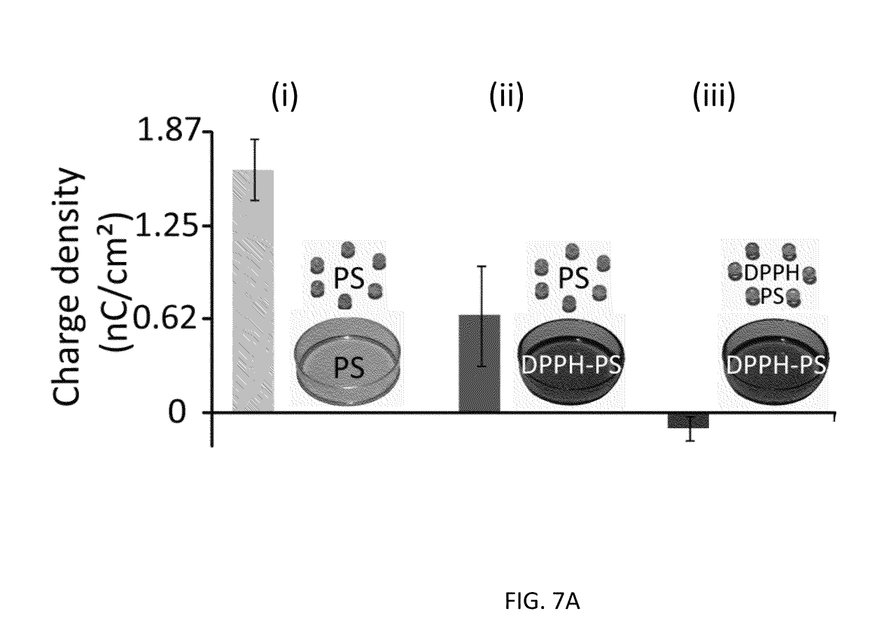

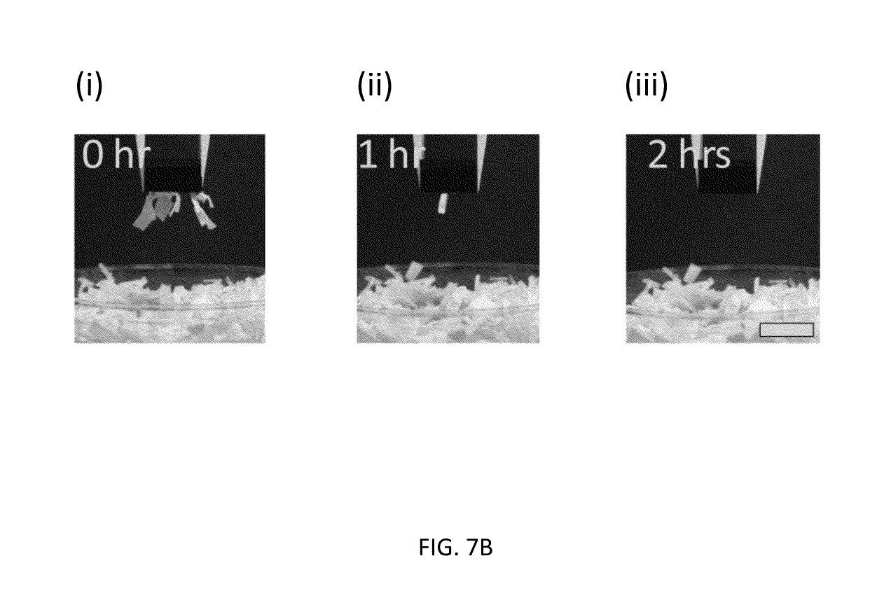

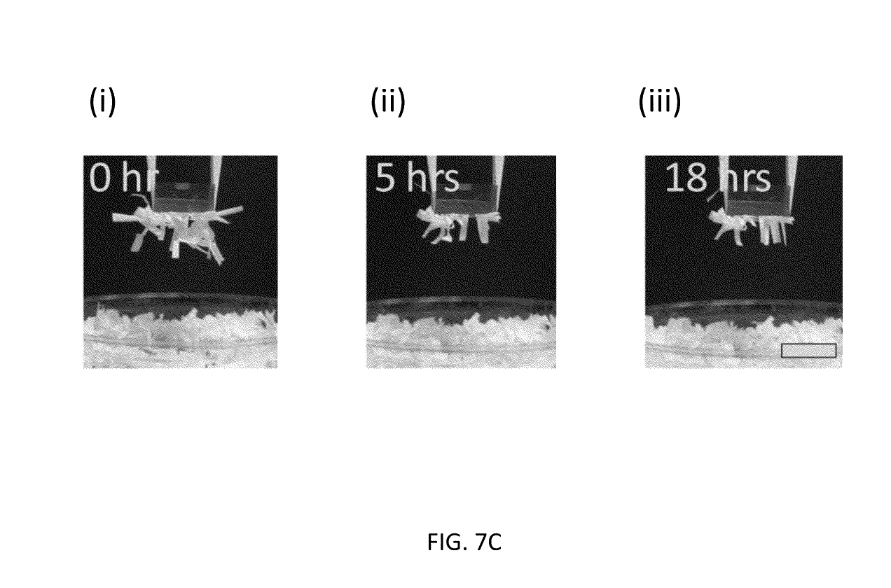

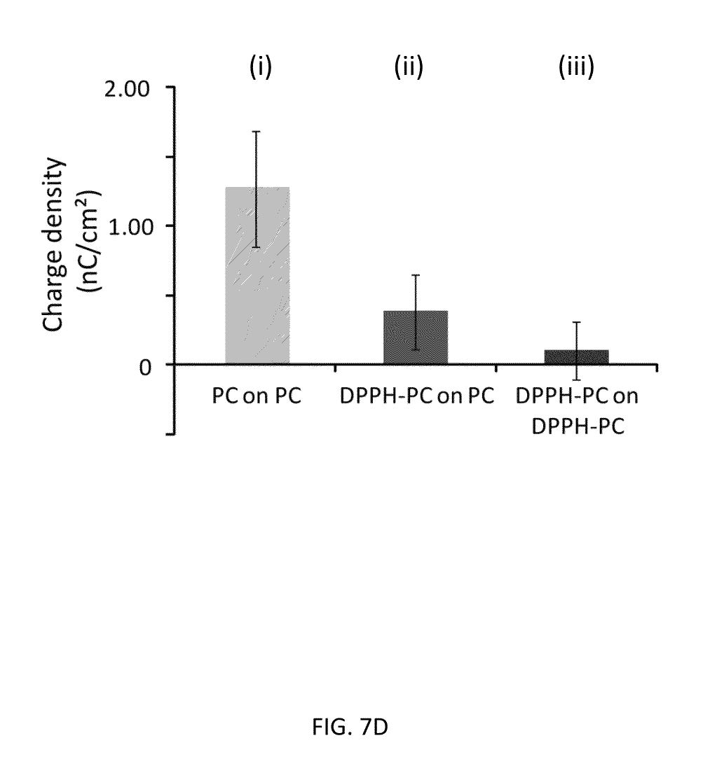

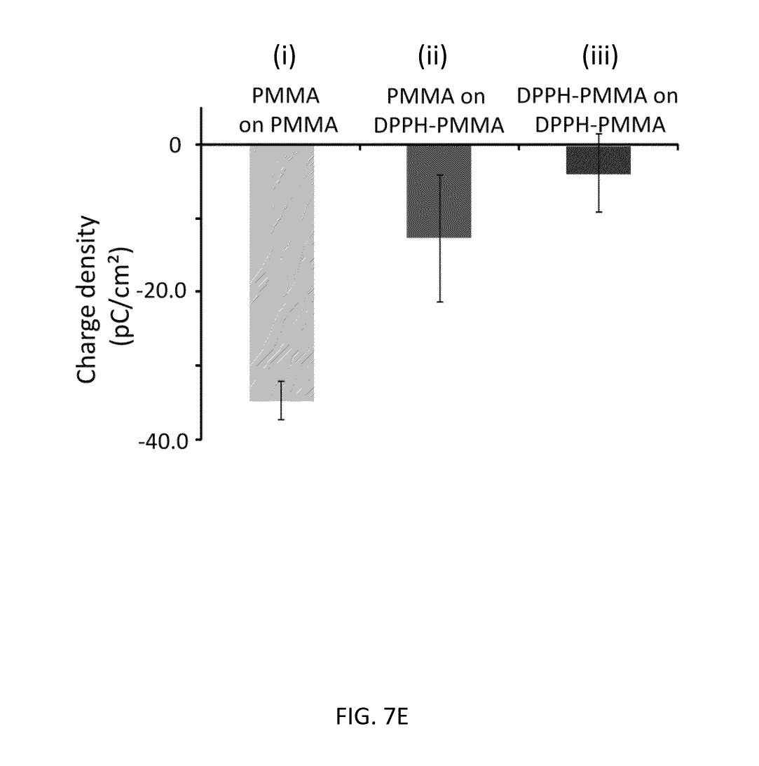

The practical importance of the charge-radical interplay described above is in the ability to engineer antistatic materials by simply doping common insulating polymers with small amounts of radical scavengers. FIG. 7A illustrates how PS beads shaken in a PS Petri dish change from highly-charging to virtually non-charging. FIG. 7B has another example where a piece of PDMS doped with DPPH and contact charged against PS discharges and “de-dusts” from small shreds of paper within tens of minutes. For comparison, a native/undoped PDMS charged to the same degree retains static electricity and paper shreds for over a day (FIG. 7C). Comparable antistatic protection was conferred on PC and PMMA polymers treated with the free radical scavenger DPPH (FIGS. 7D,E).

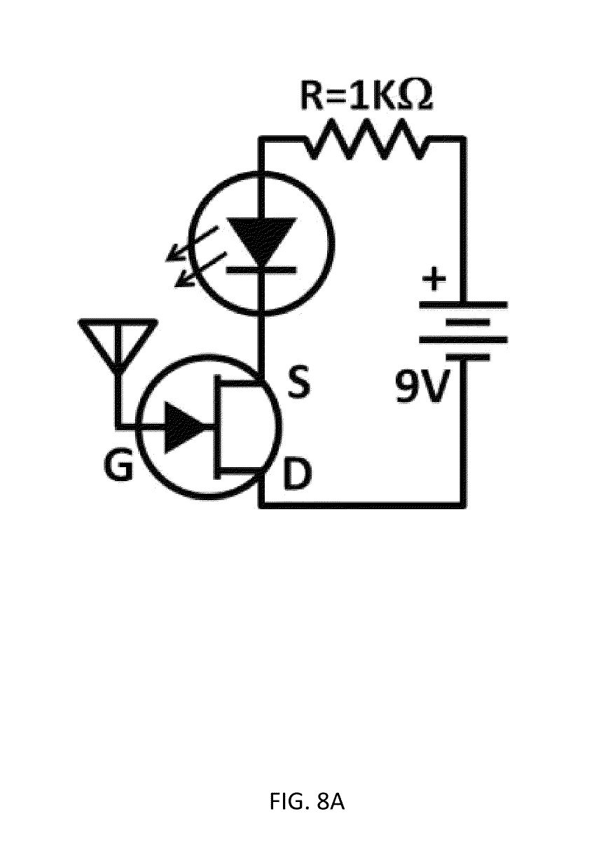

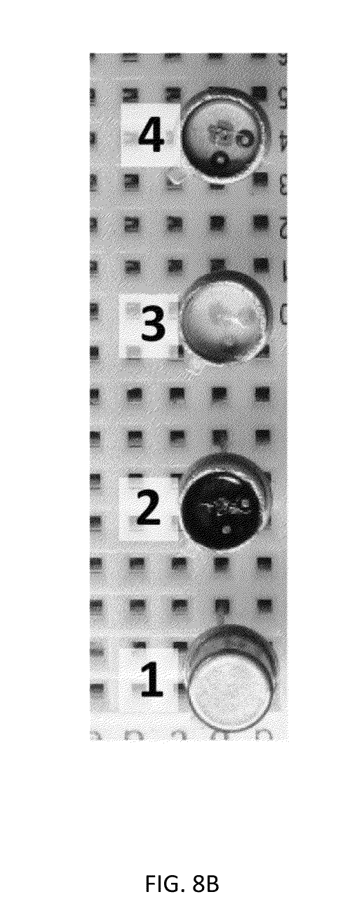

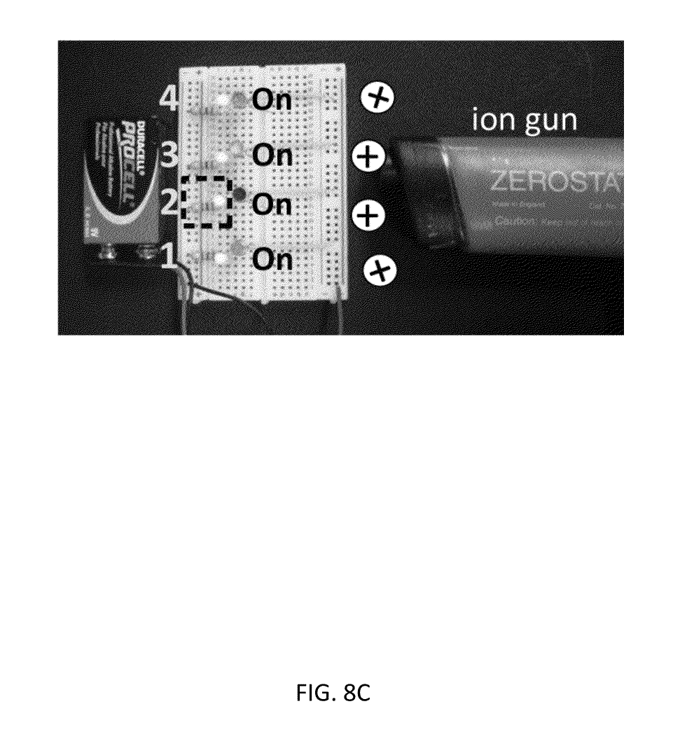

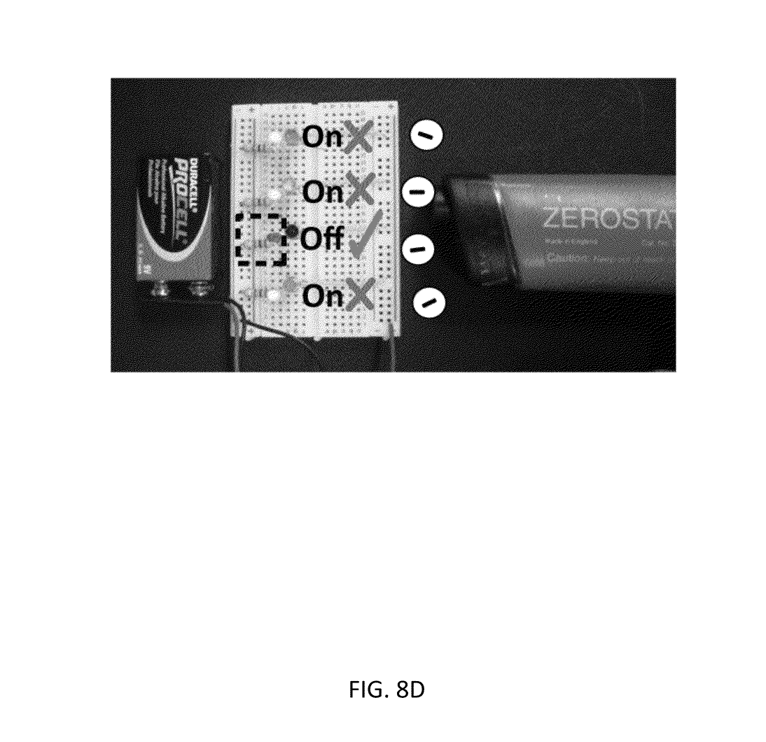

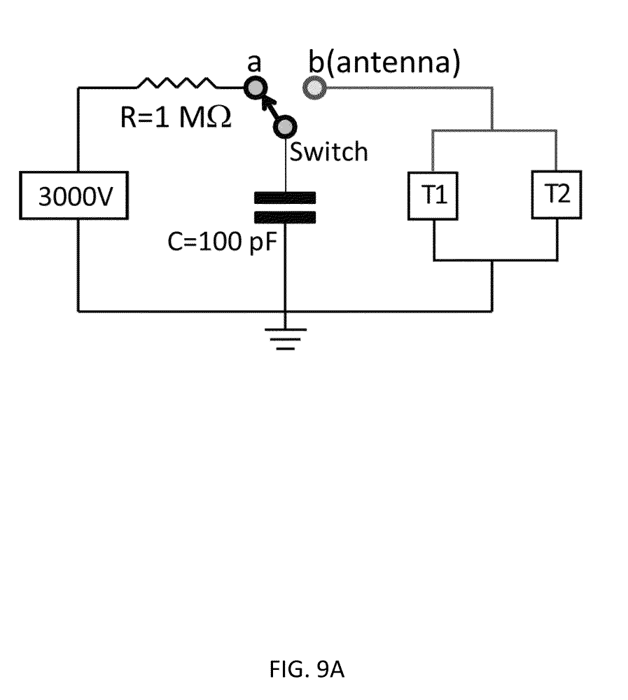

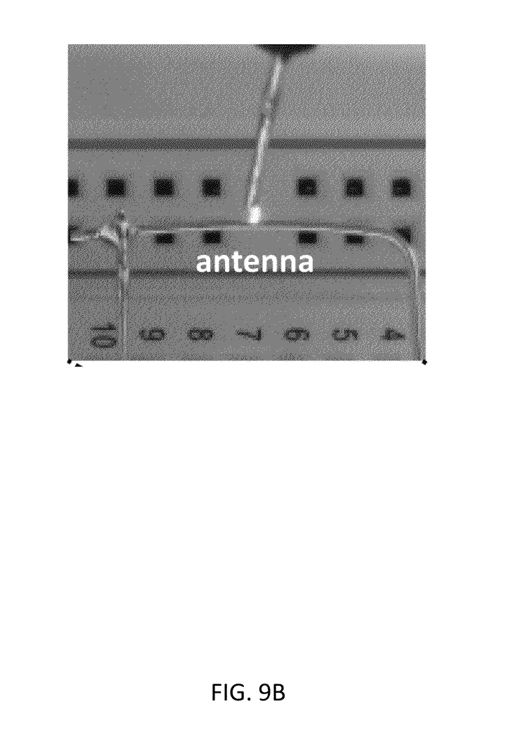

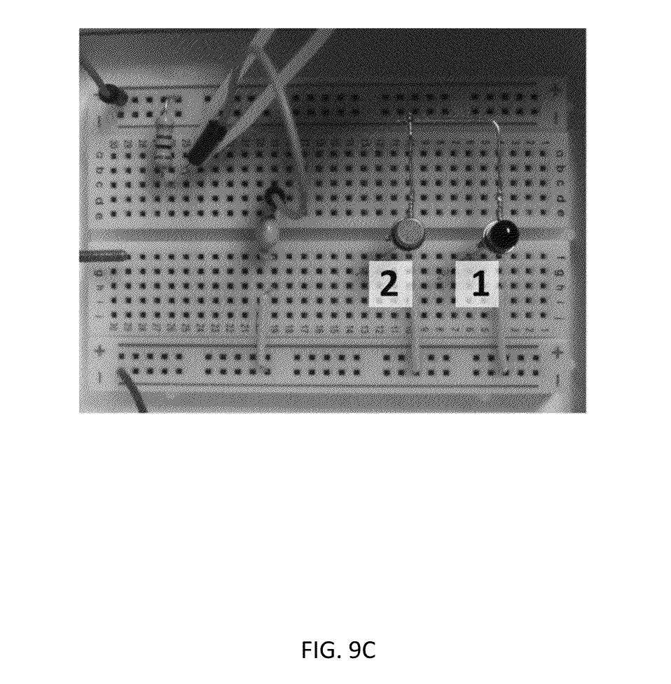

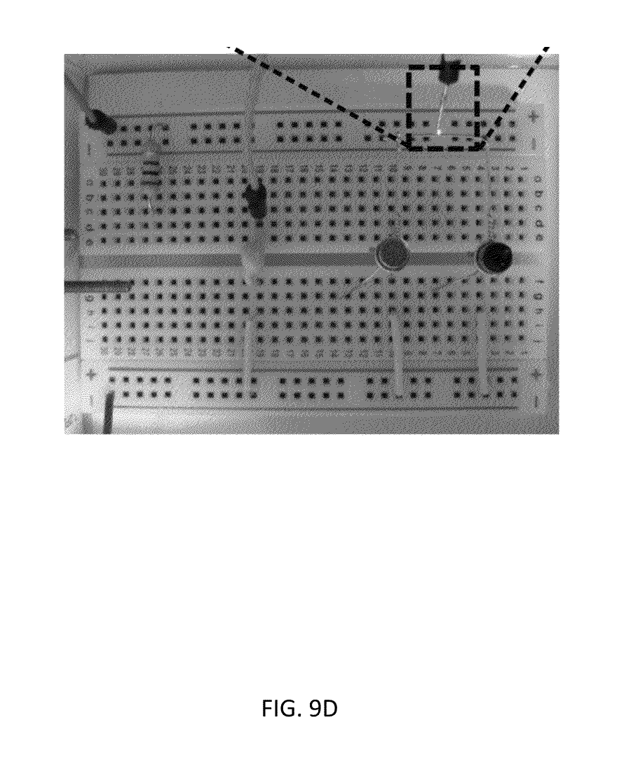

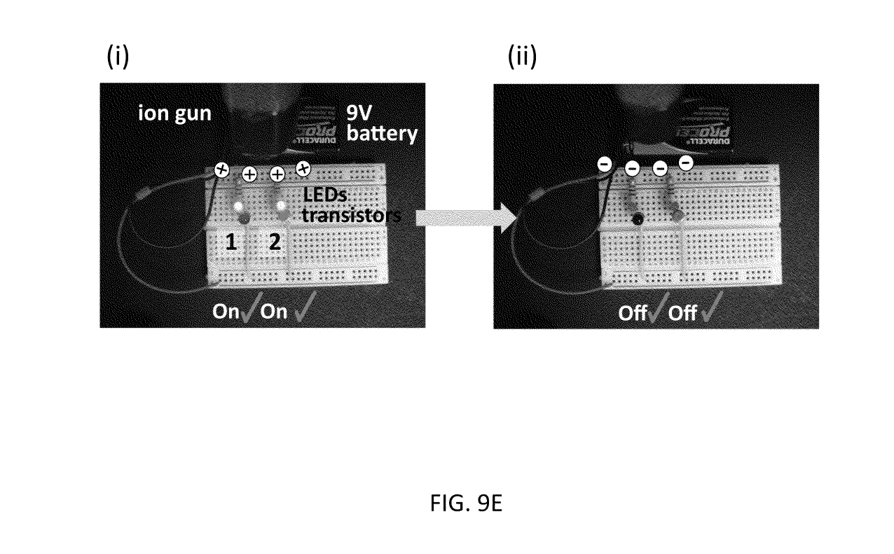

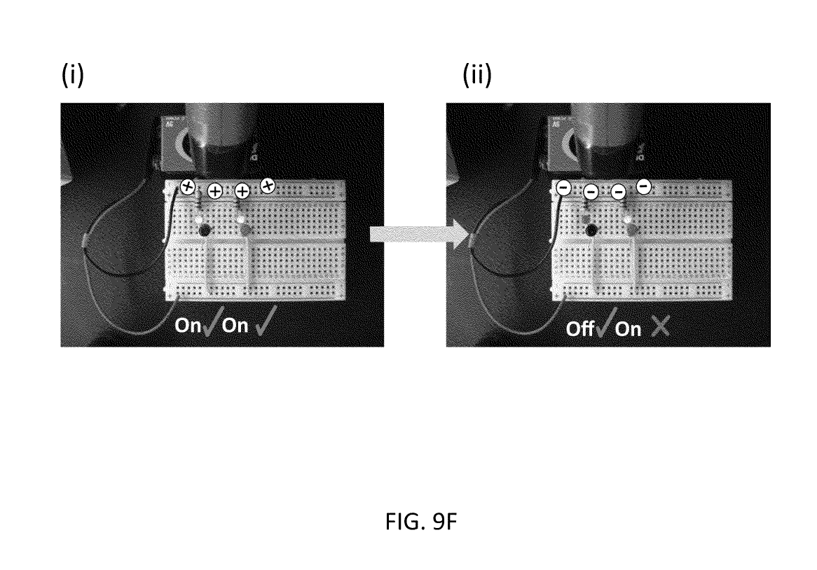

The ability of the disclosed antistatic polymer composition to effect charge-radical regulation is illustrated in two exemplary electronic circuit experiments (FIGS. 8 and 9). PS doped with DPPH can be used to protect electronic components from failure due to electrostatic discharge, which is a ubiquitous problem in the microelectronics industry damaging semiconductor-based devices (either upon direct contact or arcing), and resulting in losses currently measured in billions of dollars per year. The circuit shown comprises n-channel JFET (2N 4861A, Solitron Devices) transistors connected serially to LED diodes (FIGS. 8A,B). When exposed to consecutive (+/−) cycles of electrostatic/corona discharge from an electrostatic gun, the LEDs connected to undamaged transistors go cyclically “on” and “off”. If, however, the accumulation of static electricity on the gate damages the transistor, its associated LED should always be “on”. Four types of transistors were employed in the circuit use: #1 was an intact JFET, #2 was a JFET with the metal shield removed but with the gate covered with a 200-500 mm-thick layer of polystyrene, PS, doped with 1.8% w/w DPPH; #3 had the shield removed but the gate was covered with pure PS, and #4 had the shield removed with no polymer on the gate. As shown in FIGS. 8C,D, the ion gun causes the damage of all transistors but #2, for which DPPH helps scavenge the radicals produced by corona discharge thus destabilizing the accumulated charges and preventing the build-up of static electricity to damaging levels.

Referring to FIG. 9, the effects of free radical scavengers were evaluated in protecting a circuit transistor during capacitor discharge. The circuit design shown in FIG. 9A was constructed. A100 pF capacitor is charged from a 3000 V high-voltage source for 10 seconds until complete charging. Then, upon switching from (a) to (b) (refer to FIG. 9A), the transistors being tested are subjected to a discharge from this capacitor through a common metal antenna (FIG. 9B), wherein the transistors are connected to yield electrostatic discharge from D to G or S to G, where D=drain, S=Source, and G=gate (grounded)). FIG. 9C illustrates the experimental photograph of the circuit, and the charging of the capacitor from the high voltage source through a 1 MΩ resistor. After the removal of its cap, transistor #1 (T1) was covered with DPPH-PDMS while transistor #2 (T2) was not modified as seen in FIG. 9C. Both transistors were connected in parallel. FIG. 9D depicts discharging the capacitor on transistors through metal antenna connected to the gates of the transistors. Before capacitor-discharge both transistors work properly even upon charging from proximal (but not directly touching the gates) ion gun. Upon (+) ion-gun discharge, the LEDs connected to both transistors are on, and upon (−) charging they are off (FIG. 9E). However, after the capacitor discharge, DPPH-PDMS covered transistor #1 still functions properly upon (+) and (−) charging, but transistor #2 is always on, indicating its irreversible damage (FIG. 9F).

Since similar effects are observed with other types of polymers and scavengers studied including notably, the edible and biocompatible vitamin E. These results provide a general, technically straightforward and environmentally “green” way of protecting electronics of various types from the untoward effects of static electricity.

In view of the foregoing, disclosed herein as a first aspect of the invention is an anti-static polymer composition. The composition includes a polymer and a free radical scavenger additive. In a first respect, the polymer is selected from a group consisting of poly(dimethyl siloxane), poly(methyl methacrylate), polycarbonate, polystyrene, styrene-butadiene-styrene, styrene-ethylene/butylene-styrene, styrene-ethylenepropylene, styrene-isoprene-styrene, polyacrylate, polypropylene, butyl rubber, natural rubber, silicone rubber, ethylene-vinyl acetate, polyvinylether and nitrile. In a second respect, the polymer comprises an acrylate-based polymer. In a third respect, the polymer comprises a composition having the propensity to charge, retain or discharge static electricity. In a fourth respect, the free radical scavenger additive is selected from a group consisting of (±)-α-tocopherol, bis(1-octyloxy-2,2,6,6-tetramethyl-4-piperidyl) sebacate, 2,2-diphenyl-1-picrylhydrazyl, curcumin, ascorbic acid, and β-carotene. In a fifth respect, the free radical scavenger additive contacts a surface of the polymer. In a sixth respect, the free radical scavenger additive is disposed on a surface of the polymer by dipping, brushing, flow-coating, screen-printing, slot-die coating, gravure coating, powder coating, spraying and spin-coating. In a seventh respect, the free radical scavenger additive is present at a final concentration of at least about 0.01 mM. In an eighth respect, the free radical scavenger additive is present at a final concentration in the range from about 0.01 mM to about 10.0 mM, including any sub-range having numerical values of concentration within this range.

In a second aspect of the invention, an electrostatic sensitive device having reduced propensity to retain static electricity is disclosed. The device includes the electrostatic sensitive device and an anti-static polymer composition. The anti-static polymer composition includes a polymer and a free radical scavenger additive. In a first respect, the anti-static polymer composition contacts a surface of the electrostatic sensitive device. In a second respect, the anti-static polymer composition is disposed on a surface of the electrostatic sensitive device by dipping, brushing, flow-coating, screen-printing, slot-die coating, gravure coating, powder coating, spraying and spin-coating. In a third respect, the polymer is selected from a group consisting of poly(dimethyl siloxane), poly(methyl methacrylate), polycarbonate, polystyrene, styrene-butadiene-styrene, styrene-ethylenebutylene-styrene, styrene-ethylenepropylene, styrene-isoprene-styrene, polyacrylate, polypropylene, butyl rubber, natural rubber, silicone rubber, ethylene-vinyl acetate, polyvinylether and nitrile. In a fourth respect, the free radical scavenger additive is selected from a group consisting of (±)-α-tocopherol, bis(1-octyloxy-2,2,6,6-tetramethyl-4-piperidyl) sebacate, 2,2-diphenyl-1-picrylhydrazyl, curcumin, ascorbic acid, and β-carotene.

In a third aspect of the invention, a method of reducing the propensity of a polymer to retain static electricity upon electrification of the polymer is disclosed. The method includes the step of doping the polymer with a free radical scavenger additive. In a first respect, doping the polymer with a free radical scavenger additive includes disposing the free radical scavenger additive on a surface of the polymer by dipping, brushing, flow-coating, screen-printing, slot-die coating, gravure coating, powder coating, spraying and spin-coating a solution comprising the free radical scavenger additive on the surface of the polymer. In a further elaboration of the first respect, the additional step of drying the solution comprising the free radical scavenger additive on the surface of the polymer is provided. In a second respect, the polymer is selected from a group consisting of poly(dimethyl siloxane), poly(methyl methacrylate), polycarbonate, polystyrene, styrene-butadiene-styrene, styrene-ethylenebutylene-styrene, styrene-ethylenepropylene, styrene-isoprene-styrene, polyacrylate, polypropylene, butyl rubber, natural rubber, silicone rubber, ethylene-vinyl acetate, polyvinylether and nitrile. In a third respect, the free radical scavenger additive is selected from a group consisting of (±)-α-tocopherol, bis(1-octyloxy-2,2,6,6-tetramethyl-4-piperidyl) sebacate, 2,2-diphenyl-1-picrylhydrazyl, curcumin, ascorbic acid, and β-carotene. In a fourth respect, the free radical scavenger additive is present at a final concentration in the range from about 0.01 mM to about 10.0 mM.

### EXAMPLES

The invention will be more fully understood upon consideration of the following non-limiting examples, which are offered for purposes of illustration, not limitation.

### Example 1

### Materials and Instrumentation

Materials

Poly(dimethylsiloxane) (PDMS) was prepared by mixing a degassed elastomer base and a crosslinker in a 10:1 w/w ratio (Sylgard 184, Dow Corning). Prepolymer mixture was cast on an atomically flat silicon wafer (Montco Silicon Technologies, Inc.), silanized with 1H,1H,2H,2H-perfluorooctyltrichlorosilane, and cured at 65° C. for 24 h. After curing the prepolymer, the PDMS pieces (ca. 1 cm×1 cm×0.5 cm) were gently peeled off the wafer, washed with 3×1 L of dichloromethane for 24 hrs (to remove catalyst and unreacted monomers) and thoroughly dried prior to the charging experiments.

Instrumentation

All surface images were obtained on a Bruker Dimension Icon AFM microscope. For quantitative measurement of mechanical properties, PeakForce QNM software was used which gave DMT moduli data as direct maps, using PDMS standard of 6.0 MPa. SNL-10 tips (spring constant, k=0.35 Nm) were used in the QNM measurements. For potential (KFM) measurements, conductive SCM-PIT tips (resonance frequency, f=70 kHz) were used, lift height was kept at 100 nm during the potential scan. For magnetic force (MFM) measurements, conductive MESP tips (resonance frequency, f=75 kHz) were used, and lift height was kept at 100 nm during imaging. XPS spectra were recorded on an XPS spectrometer, ESCA Lab 250 that was equipped with EA125 energy analyzer. Photoemission was stimulated by a monochromatic Al κ alpha radiation (1486.6 eV) with the operating power of 300 W. Survey scans and high-resolution scans were collected using pass energies of 70 eV and 26 eV, respectively. Analyzer substrate angle was 45°. Binding energies in the spectra were referenced to the C1s binding energy set at 285 eV. At least three different measurements were performed for each sample. SEM images were taken on a LEO Gemini 1525.

Cross-Correlation Image Analysis.

The mutual localization of charges (visualized by KFM), radicals (by MFM), and transferred material (by AFM-phase) over the same scan domain was quantified by calculating the cross-correlation function defined as:

$$γ ( x , y ) = \frac{{\sum }_{i , j}^{ } [ w ( i , j ) - \overline{w} ] [ f ( x + i , y + j ) - \overline{{f}_{ij}} ]}{\sqrt{{\sum }_{i , j}^{ } {[ w ( i , j ) - \overline{w} ]}^{2} {\sum }_{i , j}^{ } {[ f ( x + i , y + j ) - \overline{{f}_{ij}} ]}^{2}}}$$

Where w and f denote the images being compared and displaced by (x,y) with respect to each other, f̅ᵢⱼ is the mean pixel value in the region where w and f overlap, and w̅ is the mean pixel value of image w. The indices i and j are the pixel indices corresponding to the region of w and f that is overlapping at a displacement (x,y). The values of γ(x,y) can range between −1 and +1, corresponding to perfect negative and positive correlations, respectively, of the two images being compared. The p-values were calculated from the Student's t-value defined as t=γ(x, y){square root over ((n−2)/(1−γ(x, y)²))} (where n is the number of rows in the image), using the corrcoef function in MATLAB. While the values of the correlation function γ(x,y) quantify how strong the correlation between the two images is, the p values measure the significance of the correlation.

### Example 2

### Scotch™ Tape Experiments

In some of the contact-charging experiments, a commercial Scotch™ tape from 3M was used. While results were qualitatively similar for all other pairs of polymers we tested, the Scotch™ tape is a convenient model system since the surfaces to be separated are initially in conformal contact (thus eliminating any artifacts related to contact imperfections), and material transfer can be easily quantified. When the tape was peeled off (with typical speed ˜1 cm/sec), it developed surface charge density on the order of 1 nC/cm² (measured by a house-made Faraday cup & cage system).

### Example 3

### Corona-Discharge Experiments

PDMS pieces prepared according to the Materials and Methods section above were charged by ten “shots” from an ion gun (Zerostat, Sigma Aldrich) held 1 cm away from the surface of the polymers: pulling the trigger of the gun produced positively charged ions (and positive charges on the polymer's surface) while releasing the trigger generated negative ions and negative charges on the polymer.

### Example 4

### Choice of the System and PDMS Experiments

A series of contact charging experiments were performed with native polymers as well as polymers doped with chemical substances scavenging the radicals. In particular, in the studies described in FIG. 3, poly(dimethylsiloxane) (PDMS) was contact-charged against polystyrene (PS). This choice was motivated by five characteristics of this system: (i) PDMS can be made atomically flat (by casting and curing against a silicon wafer master, see Materials and Methods above) and comes into conformal contact with PS; (ii) material transfer—predominantly unidirectional from softer PDMS onto harder PS—has been characterized in detail in our previous work; (iii) we previously documented the creation of charge-mosaics as well as mechanoradicals on these contact-charged materials; (iv) at each PDMS/PS contact, the charge magnitudes do not depend on the contact time, speed of separation etc.); and (v) PDMS can be uniformly doped with free-radical scavengers such as (±)-α-tocopherol (vitamin E), bis(1-octyloxy-2,2,6,6-tetramethyl-4-piperidyl) sebacate (HALS), or 2,2-diphenyl-1-picrylhydrazyl (DPPH).

### Example 5

### Doping PDMS with Radical Scavengers

PDMS pieces prepared as described previously were immersed into 0.5×10⁻² M and 1.0×10⁻³M solutions of radical scavengers, e.g., DPPH, in dichloromethane. The swollen polymer pieces were first dried in air and then under high vacuum for 48-96 hrs prior to experiments. To ascertain that no residual solvent had any effect on the charging, control experiments were also performed with (i) pure PDMS, and (ii) pure PDMS soaked in dichloromethane and then dried as described above. No differences in the charging characteristics of these two “types” of pure PDMS were observed.

### Example 6

### Discharge Prior to Experiments

Prior to charging, PDMS pieces were left to discharge for at least 24 hrs under argon. The electroneutrality (i.e., lack of any detectable charge) of these pieces was confirmed in two ways (1) by measurements using a house-made Faraday cup connected to a high precision electrometer (Keithley Instruments, model 6517B). Only pieces with net charge densities below the electrometer's detection limit <±0.005 nC/cm², were considered to be neutral (vs. densities above 0.1-0.2 nC/cm² after charging) and used in further experiments; (2) by Kelvin Force Microscopy (KFM) potential imaging; here neutrality was assumed if the highest potential on the scanned surface did not exceed 10 mV (vs. >500 mV for electrified pieces). For images of PDMS prior to electrification, see FIG. IA-C.

Quantification of Charging.

The overall/net charges on the macroscopic pieces of native and doped PDMS pieces developed during charging were measured using a house-made Faraday cup connected to a high precision electrometer (Keithley Instruments, model 6517B).

Surface Resistivity Measurements.

Surface resistivities of PDMS, and DPPH-PDMS were measured using a two-probe method, with w=4.26 mm wide samples, and the distance between electrodes d=100 mm. I-V curves were collected on a Keithley electrometer (6517B) that served as the voltage source and also measured the generated current. Applied voltage was changed from 0 to 100 V in steps of 10 V and also from 0 to −100 V in steps of 10 V, which gave identical results in terms of conductivity. Form the slopes of the I-V curves, the values were calculated for surface resistivity, Rs, according to equation Rs=(V/I)·(w/d). For PDMS, DPPH-PDMS (1 mM and 5 mM) the measured surface resistivities were determined to be ca. 10¹⁶ ohm/sq.

### Example 7

### Synthesis of DPPH-H

0.4 g, 1.0 mmol of DPPH was dissolved in argon-purged THF (100 mL). With stirring, H₂O₂ (30% w/w, 20 eq.) was introduced into this solution dropwise at room temperature. After further stirring for two days, by which time the dark violet color of the solution turned to red-brown, the solution was washed with 3×100 mL of water, dried over MgSO₄, and then evaporated under high vacuum. The remaining solid was purified by column chromatography (using dichloromethane on silica gel). The first band (dark red) was collected to give the final product in 90% yield (0.36 g). ¹H NMR (400 MHz, CDCl₃) δ0.12 (s, 1H), 9.22 (s, 1H), 8.52 (s, 1H), 7.35 (t, J=8.04 Hz, 4H), 7.21 (t, J=7.75 Hz, Hz, 2H), 7.11 (d, J=7.75 Hz, 4H); ESI-MS (neg) me: [M-H]⁻¹ calcd. for C₁₈H₁₂N₅O₆⁻ 394.08, found 393.95.

### Example 8

### Experiments with Charging PS Beads

Polystyrene (PS) spheres (1.6 mm) were purchased from Engineering Laboratories Inc. (cat. #BL00625STNA2CC). Polystyrene dishes (35 mm×10 mm) were from VWR (cat. #25382-064). Prior to experiments, both materials were carefully washed with ethanol and dried at 40° C. for several hours. To avoid contamination with dust etc., all subsequent manipulations/procedures were performed in a glove box. The initial charges on the beads (<10 pC) were measured using a house-made Faraday cup connected to a Keithley 6517 electrometer. The beads were placed into a dish, which was affixed to a computer-controlled linear motor (LinMot, P01-23×160). The shaking parameters used in the experiments were 90 sec shaking time, 10 Hz shaking frequency and 25 beads in each dish. After a predetermined shaking time, the beads were carefully removed from the dish one by one, and their charges were measured in a Faraday cup.

To dope with DPPH, the beads and dishes were immersed into a 1 mM solution of DPPH in propylene glycol monomethyl ether acetate and left for 5 min to allow DPPH to soak into the polymer. The polymer pieces were then removed from the solution, carefully dried in air and then under vacuum for 48-96 hours. Lack of any residual solvent effects on charging was ascertained by comparing (i) pure beads; (ii) pure beads soaked in propylene glycol monomethyl ether acetate and then dried.

### REFERENCES

Baytekin H T, Baytekin B, Hermans™, Kowalczyk B, Grzybowski B A “Control of surface charges by radicals as a principle of antistatic polymers protecting electronic circuitry,” Science 341:1368-71 (2013) [doi: 10.1126science.1241326].

All of the patents, patent applications, patent application publications and other publications recited herein are hereby incorporated by reference as if set forth in their entirety.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

The invention claimed is:

1. An anti-static polymer composition comprising:
a polymer; and
a free radical scavenger additive.

2. The anti-static polymer composition of claim 1, wherein the polymer is selected from a group consisting of poly(dimethyl siloxane), poly(methyl methacrylate), polycarbonate, polystyrene, styrene-butadiene-styrene, styrene-ethylenebutylene-styrene, styrene-ethylenepropylene, styrene-isoprene-styrene, polyacrylate, polypropylene, butyl rubber, natural rubber, silicone rubber, ethylene-vinyl acetate, polyvinylether and nitrile.

3. The anti-static polymer composition of claim 1, wherein the polymer comprises an acrylate-based polymer.

4. The anti-static polymer composition of claim 1, wherein the polymer comprises a composition having the propensity to charge, retain or discharge static electricity.

5. The anti-static polymer composition of claim 1, wherein the free radical scavenger additive is selected from a group consisting of (±)-α-tocopherol, bis(1-octyloxy-2,2,6,6-tetramethyl-4-piperidyl) sebacate, 2,2-diphenyl-1-picrylhydrazyl, curcumin, ascorbic acid, and p-carotene.

6. The anti-static polymer composition of claim 1, wherein the free radical scavenger additive contacts a surface of the polymer.

7. The anti-static polymer composition of claim 1, wherein the free radical scavenger additive is disposed on a surface of the polymer by dipping, brushing, flow-coating, screen-printing, slot-die coating, gravure coating, powder coating, spraying and spin-coating.

8. The anti-static polymer composition of claim 1, wherein the free radical scavenger additive is present at a final concentration of at least about 0.01 mM.

9. The anti-static polymer composition of claim 1, wherein the free radical scavenger additive is present at a final concentration in the range from about 0.01 mM to about 10.0 mM.

10. An electrostatic sensitive device having reduced propensity to retain static electricity, comprising:
the electrostatic sensitive device; and
an anti-static polymer composition,
wherein the anti-static polymer composition comprises:
a polymer; and
a free radical scavenger additive.

11. The electrostatic sensitive device of claim 10, wherein the anti-static polymer composition contacts a surface of the electrostatic sensitive device.

12. The electrostatic sensitive device of claim 10, wherein the anti-static polymer composition is disposed on a surface of the electrostatic sensitive device by dipping, brushing, flow-coating, screen-printing, slot-die coating, gravure coating, powder coating, spraying and spin-coating.

13. The electrostatic sensitive device of claim 10, wherein the polymer is selected from a group consisting of poly(dimethyl siloxane), poly(methyl methacrylate), polycarbonate, polystyrene, styrene-butadiene-styrene, styrene-ethylenebutylene-styrene, styrene-ethylenepropylene, styrene-isoprene-styrene, polyacrylate, polypropylene, butyl rubber, natural rubber, silicone rubber, ethylene-vinyl acetate, polyvinylether and nitrile.

14. The electrostatic sensitive device of claim 10, wherein the free radical scavenger additive is selected from a group consisting of (±)-α-tocopherol, bis(1-octyloxy-2,2,6,6-tetramethyl-4-piperidyl) sebacate, 2,2-diphenyl-1-picrylhydrazyl, curcumin, ascorbic acid, and p-carotene.

15. A method of reducing the propensity of a polymer to retain static electricity upon electrification of the polymer, the method comprises:
doping the polymer with a free radical scavenger additive.

16. The method of claim 15, wherein doping the polymer with a free radical scavenger additive comprises disposing the free radical scavenger additive on a surface of the polymer by dipping, brushing, flow-coating, screen-printing, slot-die coating, gravure coating, powder coating, spraying and spin-coating a solution comprising the free radical scavenger additive on the surface of the polymer.

17. The method of claim 16, further comprising drying the solution comprising the free radical scavenger additive on the surface of the polymer.

18. The method of claim 15, wherein the polymer is selected from a group consisting of poly(dimethyl siloxane), poly(methyl methacrylate), polycarbonate, polystyrene, styrene-butadiene-styrene, styrene-ethylenebutylene-styrene, styrene-ethylenepropylene, styrene-isoprene-styrene, polyacrylate, polypropylene, butyl rubber, natural rubber, silicone rubber, ethylene-vinyl acetate, polyvinylether and nitrile.

19. The method of claim 15, wherein the free radical scavenger additive is selected from a group consisting of (±)-α-tocopherol, bis(1-octyloxy-2,2,6,6-tetramethyl-4-piperidyl) sebacate, 2,2-diphenyl-1-picrylhydrazyl, curcumin, ascorbic acid, and β-carotene.

20. The method of claim 15, wherein the free radical scavenger additive is present at a final concentration in the range from about 0.01 mM to about 10.0 mM.
